(19) United States
(12) Patent Application Publication
(10) Pub. No.: US 2015/0178847 A1
(43) Pub. Date: Jun. 25, 2015

(54) APPARATUS AND METHOD FOR PATENT PORTFOLIO MANAGEMENT

(71) Applicants: YASUHIRO TABATA, TOKYO (JP); RAYTEC CO., LTD., TOKYO (JP)

(72) Inventors: Yasuhiro TABATA, Kanagawa (JP); Takanobu DEGUCHI, Tokyo (JP)

(73) Assignees: RAYTEC CO., LTD., TOKYO (JP); YASUHIRO TABATA, TOKYO (JP)

(21) Appl. No.: 14/583,088

(22) Filed: Dec. 24, 2014

(30) Foreign Application Priority Data
Dec. 25, 2013 (JP) 2013-267601

(51) Int. Cl. G06Q 40/06; G06Q 50/18

(52) U.S. Cl. CPC G06Q 40/06; G06Q 50/184

(57) ABSTRACT

[TECHNICAL PROBLEM] An evaluation score and information of a group of applications and patents mutually related with each other to constitute a patent portfolio are visualized so that an effective value evaluation is realized.

[SOLUTION] A patent portfolio management system, comprising: a patent value calculation unit that calculates a value score of an individual application stored in the patent information storage unit; an annual fee payable amount calculation unit that calculates a patent annual fee payable amount for a reference year of the subject application for the evaluation based on the annual fee table stored in the annual fee information storage unit; a graphics generation device that generates a patent portfolio management screen inclusive of a preliminarily determined diagram or a preliminarily determined table; and a display device that displays the patent portfolio management screen generated by the graphics generation device.

### CROSS REFERENCE TO RELATED APPLICATION

The present application claims priority under the Paris Convention to Japan Patent Application No. 2013-267601, filed on Dec. 25, 2013. The entire content of such prior application is incorporated herein by reference.

### TECHNICAL FIELD

The present invention relates to an apparatus and a method for patent portfolio management adapted to provide an evaluation information per each of groups of patent applications and patents constituting a patent portfolio, based upon the evaluation information of each of individual patent applications constituting the patent portfolio, and thereby to assist in determining whether to maintain or abandon per each of the groups of the patent applications and the patents. The patent portfolio is constituted by a collection of groups each of which includes patent applications and patents mutually associated with each other.

### BACKGROUND ART

Up until now, in a patent management field, there have been made evaluations as to whether or not a patent application or a registered patent is still needed for an applicant at the present time, or as to whether or not the patent application or the registered patent is still indispensable in view of utilization in the future. It is sometimes the case that a patent application was filed based on a decision at the time when the invention was made, however the technology becomes obsolete as an elapse of time or a research and development strategy is changed thereafter, so that the applicant no longer finds it necessary to have the invention expeditiously patented or to maintain the registered patent.

Failure to perform the above-mentioned evaluation on a periodical basis can result in an increase of unnecessary costs and patents for the applicant. Payment of maintenance fee to the government of each country is necessary simply to maintain the patent application or the patent. Furthermore, such maintenance fee generally shifts sharply higher toward later years of the patent term, thereby further increasing a cost burden for the applicant.

Periodical evaluations are normally conducted among applicants or corporations for reducing those unnecessary applications and costs.

Although there are some variations, following two approaches are generally adopted in corporations: (1) a series of patents are evaluated in a lump after elapse of a predetermined period of time, such as for example ten years or fifteen years, after filing the applications; (2) a series of patents within a predetermined period of time, such as for example three years or five years, counting backward from the expiration of the patent term are evaluated in a lump.

The reason why above-mentioned approaches are adapted is because, in most of the countries or regions, the application maintenance annual fee and patent maintenance annual fee are generally higher in response to elapse of years after the application filing or toward the expiration of the patent term.

Other than those “in-a-lump” approaches, in such a case that a research and development is cancelled or that a business is sold to another corporation, all of the related patents and rights are evaluated as a whole in order to make a determination as to whether or not those patents and rights be further maintained. Nevertheless, such an evaluation as mentioned above is still a one-off approach even though the scope of evaluation encompasses all the related patents and rights.

An example of sill another one-off approach can be such that, in studying an office action issued in a patent prosecution stage, if a patent registration is determined to be no longer necessary, the patent application can be abandoned at that timing. And, in such an occasion, abandonment of corresponding applications filed in other countries may be considered as well at the same time.

From the foregoing descriptions, it will be understood that any one of above mentioned approaches is a one-off approach of evaluation for the patents and rights. Even if the evaluation scope encompasses all the related patents and rights, such an approach is still a one-off approach of evaluation.

There are three points to be noted in the evaluation of patents. (1) The first point to be noted is an effective patent budget management to reduce or suppress increasing patent annual fees, so that the patent budget can be assigned to filing new patent applications. (2) The second point to be noted is an excavation of useful applications and patents that can he utilized, as well as finding out unnecessary applications and patents. Reevaluation of applications and patents owned by the corporation and investigation of practice status inside and outside of the corporation can trigger an excavation of applications and patents that can be utilized. (3) The third point to be noted is an efficiency of evaluation. The evaluation is performed by engineers belonging to the research and development section related to the invention. However, an evaluation work gives a large burden to the engineers engaged in the evaluation work in the intervals of their main job of research and development. How the evaluation can be conducted properly while reducing the burden is the greatest challenge.

The evaluation of a large number of applications and patents easily goes beyond a limit of manual work, so that an information technology (IT) system must be utilized. The IT technology has dramatically improved efficiency of a workflow of extracting evaluation subjects and evaluating the extracted evaluation subjects, inputting the evaluation results and then processing thereafter.

Nevertheless, the fact is that sufficient attention is not paid to a portion of the evaluation work manually performed by human, such as for example, determination of: what kind of patents should be extracted and evaluated for effective evaluation; and what kind of information should be provided to evaluators for effective evaluation. In fact, this portion is extremely important in evaluation of the applications and patents.

Following problems may occur in absence of due attention by evaluators. Examples are explained hereinafter.

(1) A Case that Useless Patents are Maintained

Conventional evaluation methods focus on individual application or patent. However, many of the application originate as a result of research and development, so that the applications have mutual relationship with each other, such as for example, basic patents, improvement patents and peripheral patents. These applications and patents are usually managed in the corporation as patent groups in terms of patent portfolio (hereinafter alternately referred to as “PPF” as the case may be).

However, in spite of the fact as described above, the value evaluation of the applications and patents may be performed per each of the years after filing applications or per each of the years counting backward from the patent term expiration. As a result, therefore, each of the related patents may eventually be evaluated separately. This may consequently result in a case that the inventors or engineers are requested to evaluate the related patents or rights separately, and in such a case, the inventors or engineers can determine that the patents and the rights are important based upon the value of the patent portfolio that the inventors or engineers recognize, because the value of the patents or rights in the patent portfolio as a whole or the importance of the patents or rights in the patent portfolio is not clear. However, each of the patents or rights can be an extremely small right which is not even gathering attention neither inside nor outside of the corporation.

As can be understood from the foregoing description, in many cases the inventors are not in a circumstance under which practice status can be correctly analyzed when they are requested to evaluate those applications invented and filed ten years ago. As a result, the inventors may conclude that the application or the patent should be maintained without adequate analysis. Further, it may be the case that once the application or the patent be abandoned, the inventors lose an opportunity for future benefits of receiving corporate rewards, so that an incentive for abandoning may not function for the inventors.

(2) A Case that Useful Patents are Abandoned

In contrast with the above-mentioned case (1), there can be such a case that the patents or rights that should be fundamentally maintained for the corporation are mistakenly abandoned. For example, the inventors may not remain in the same section of the corporation for a long period of time, such as for example fifteen years, after filing the application, the inventor may have left the corporation and may be working in another corporation, or the inventor may have already retired by reaching a mandatory retirement age. Once such an application becomes a subject of evaluation, there is no way of requesting the inventor to evaluate the application. In such a case, the evaluation is requested to an engineer in a research and development section most closely related to the invention or the technology.

However, in many cases the engineer is too busy with his or her main job to take adequate time of investigating a practice status of other person's invention inside and outside of the corporation. Therefore, there may be a case that the engineer may choose to abandon the patent without conducting the investigation, even if the investigation can reveal the fact that the pate is adequately practiced.

In a case that the patent is becoming a subject of licensing to other corporations, even if the patent is once determined to be abandoned, the determination is reversed to maintain the patent by a patent licensing section. Such licensing information is stored in a computer system of the corporation, so that the abandonment of the patent can be prevented through the confirmation of such licensing information stored in the computer system. On the other hand, however, the patent yet to be licensed to other corporations does not have such licensing information stored in the computer system, so that the patent is likely to be abandoned.

Many of the conventional patent maintenance annual fee management methods lack a definite objective of setting forth a level of a total amount of patent maintenance fees. This is due to the fact that the evaluation section is a research and development section that does not have a budget for the annual patent maintenance fees, so that the rights to be maintained and the rights to be abandoned are determined by the evaluation result by the research and development section, thereby making the total payable amount of the annual maintenance fees to be fluctuated.

However, relying upon those management methods only causes the payable annual fees (total amount) to be increased. FIG. 1 is a bar graph showing the payable annual fees (total amount) corresponding to the patents to be maintained per each year. Each of the bars represents a relative magnitude of the total payable fees per each year. A shadowed portion of each of the bars represents a magnitude of the payable total amount in connection with the newly registered rights and the newly added rights per each year. As shown in FIG. 1, the payable annual fees (total amount) are increasing year after year.

Further, the conventional patent fee management methods fail to provide a real time feedback at the moment of the evaluation the amount of the payable annual fees for the abandoned rights or the total amount of the payable annual fees until the expiration due year for the abandoned rights, in response to the abandonment of an individual right or the abandonment of a series of applications and rights. Particularly, annual fee systems vary from country to country for the corresponding foreign applications, so that it is difficult to grasp on ureal time basis the payable amount in an integrated way.

Furthermore, in a case that a part of the groups of the applications and the patents constituting a patent portfolio are abandoned, it is even more difficult to grasp the reduction amount of the annual fee of the group as a whole or the total payable amount of the annual fees until the expiration due year for the abandoned rights. Such information as described above is not provided to the research and development section and a patent management section engaged in the evaluation of the rights, so that an efficient evaluation of rights is not realized.

The patent document 1 discloses a system to integrate and enable a communication between a patent annual tee application and an asset management application, instead of conducting an intellectual property asset management and a periodical management of maintenance fees independently with each other. Nevertheless, there is little difference in a method of the system disclosed in the patent document 1 for extracting patents to be evaluated from conventional methods for the same, and the system fails to evaluate a group consisting of a plurality of patent portfolio groups.

The patent document 2 discloses a method in which each invention or a group of inventions having identical patent term are subject to be evaluated. However, the method falls in a category of conventional evaluation methods as defined in the present specification. Although the method disclosed in the patent document 2 employs a concept of patent portfolio, the method is intended for a workflow system that ensures a plurality of evaluators to be involved in the evaluation.

The patent document 3 discloses an evaluation system for determining whether to maintain or abandon an intellectual property right, adapted to calculate a score based on information inputted to predetermined evaluation items, so that a patent having a score equal to or greater than a threshold value is determined to be maintained while a patent having a score less than the predetermined value is determined to be abandoned, thereby eliminating an error in human determination. However, the system disclosed in the patent document 3 fails to have the patent portfolio group as the evaluate subject.

The patent document 4 discloses an intellectual property evaluation system that calculates an economic value of an intellectual property in accordance with predetermined parameters at each of various events taking place during a patent prosecution. The system is adapted to calculate a total value of invention capabilities, number of patents and an average value of the invention capabilities of the intellectual properties associated with a product, to calculate a present value of a profit of the product, so that the result is displayed, thereby assisting the evaluators in disposition of the intellectual properties. However, the system disclosed in the patent document 4 is not a system that evaluates the value of a group of patent portfolios in association with the annual fee management as defined in the method according to the present invention

The patent document 5 includes a recital of a background that unnecessary patents are identified through an evaluation and abandoned, in response to an annually increasing number of patents owned by the corporation and swelling amount of budget related to the intellectual properties. Disclosed in the patent document 5 is an assistance system adapted to have patent numbers inputted to be the subject of evaluation, extract a plurality of patents similar to the inputted patents by means of a conceptual search, automatically classify the patents to be evaluated into four categories calculate the number of patents for each of the categories, so that the number of patents in each category is shown in a graph, thereby assisting the evaluators determine unnecessary patents with reference to the graph. However, in the patent document 5, there cannot be found a recital for extracting patent portfolios and automatically evaluating each of the patent portfolio groups.

### CITATION LIST

### Patent Literature

Patent Document 1: National Publication of International Patent Application No. 2012-511771

Patent Document 2: National Publication of International Patent Application No. 2009-520281

Patent Document 3: Japanese Patent Application Publication No. 2013-041432

Patent Document 4: Japanese Patent Application Publication No. 2004-234233

Patent Document 5: Japanese Patent Application Publication No. 2003-281358

### SUMMARY OF INVENTION

### Technical Problem

The present invention has been made to overcome the previously mentioned conventional problems, and it is therefore an object of the present invention to provide an apparatus and method for patent portfolio management adapted to solve the above-mentioned problems occurring from the fact that a patent portfolio, constituted by groups of patent applications and patents mutually relate to each other, is divided into individual applications and patents so that each one thereof becomes a subject of a patent value evaluation, to evaluate the patent portfolio as a whole without splitting or dividing the same, and to visualize evaluation scores and information among groups of applications and patents, thereby making it possible to realize an effective patent value evaluation.

Particularly, the present invention has an objective to provide an apparatus and method for patent portfolio management which makes it possible to know an annual fee reduction amount of the group of applications and patents to be abandoned.

### Solution to Problem

In order to solve the above problems, a patent portfolio management apparatus according to claim 1 comprises: a patent information storage unit that stores therein a patent-related information related to a subject application for an evaluation; an annual fee information storage unit that stores therein an annual fee table containing an amount of annual maintenance fee for a patent application or an amount of annual maintenance fee for a patent registration for at least one country; a patent value calculation unit that calculates a value score of an individual application stored in the patent information storage unit in response to a patent portfolio value score output instruction inputted thereto; an annual fee payable amount calculation unit that calculates a patent annual fee payable amount for a reference year of the subject application for the evaluation based on the annual fee table stored in the annual fee information storage unit in response to the patent portfolio value score output instruction; a graphics generation device that generates a patent portfolio management screen inclusive of preliminarily determined diagram or a preliminarily determined table in accordance with the value score and the patent annual fee payable amount, the value score being the value score of a group of applications and patents having a predetermined relationship with each other to constitute a patent portfolio or the value score of the individual application forming a part of the patent portfolio, the patent annual fee payable amount being the patent annual fee payable amount calculated by the annual fee payable amount calculation unit; and a display device that displays the patent portfolio management screen generated by the graphics generation device.

By the above-mentioned patent portfolio management apparatus, the value score information of the groups of related applications and patents constituting the patent portfolio and the amount of annual fees for maintaining the groups or abandoning the groups can be displayed, so that the amount of the patent maintenance annual fees of the groups selected as candidates for abandonment can be known, thereby making it possible to simulate the amount of the patent annual fee to be saved. Further, by the above-mentioned patent portfolio management apparatus, the patent portfolio can be evaluated as a whole without having splitting into parts thereof, thereby making it possible to conduct an extremely effective annual fee management.

Further, a patent portfolio management method according to claim 11 comprises steps of: a step of storing a patent application number, a patent portfolio management number and a patent data used for patent evaluation into a patent information storage unit; a step of calculating a value score of an individual application per each of applications stored in the patent information storage unit, based upon a predetermined procedure; a calculation step of calculating a patent annual fee payable amount of a reference year per each of applications stored in the patent information storage unit, based upon an annual fee table containing an amount of annual maintenance fee for a patent application or an amount of annual maintenance fee for a patent registration for at least one country; a calculation step of segmenting applications stored in the patent information storing unit into segments each of which is associated with the patent portfolio management number, and having an annual fee calculation unit calculate the value score and the patent annual fee payable amount per a group of applications and patents having a predetermined relationship with each other to constitute a patent portfolio; a patent portfolio management screen generation step of generating a predetermined diagram or a predetermined table in accordance with the value score and the patent annual fee payable amount, the value score being the value score of a group of applications and patents having a predetermined relationship with each other to constitute a patent portfolio or the value score of the individual application forming a part of the group of applications and patents, the patent annual fee payable amount being the patent annual fee payable amount calculated in the first calculation step or the second calculation step; and a step of displaying the patent portfolio management screen generated in the patent portfolio management screen generation step.

By the above-mentioned patent portfolio management method, the value score information of the groups of related applications and patents constituting the patent portfolio and the amount of annual fees for maintaining the groups or abandoning the groups can be displayed, so that the amount of the patent maintenance annual fees of the groups selected as candidates for abandonment can be known, thereby making it possible to simulate the amount of the patent annual fee to be saved. Further, by the above-mentioned patent portfolio management method, the patent portfolio can be evaluated as a whole without having splitting into parts thereof, thereby making it possible to conduct an extremely effective annual fee management.

### Advantageous Effects of Invention

According to the present invention, the value score information of the groups of related applications and patents constituting the patent portfolio and the amount of annual fees for maintaining the groups or abandoning the groups can be displayed, so that the amount of the patent maintenance annual fees of the groups selected as candidates for abandonment can be known, thereby making it possible to simulate the amount of the patent annual fee to be saved. Further, according to the present invention, the patent portfolio can be evaluated as a whole without having splitting into parts thereof, thereby making it possible to conduct an extremely effective annual fee management.

### BRIEF DESCRIPTION OF THE DRAWINGS

FIG. 1 shows a chart showing a transition of annual payable fees (amount).

FIG. 2A shows a block diagram of a patent portfolio management apparatus according to an embodiment of the present invention.

FIG. 2B shows a block diagram of a patent portfolio management apparatus according to another embodiment of the present invention.

FIG. 3 shows an example of an annual fee management system screen displayed on a display device of a patent portfolio management apparatus according to an embodiment of the present invention.

FIG. 4 shows an example of a PPF schedule stored in a storage device of a patent portfolio management apparatus according to an embodiment of the present invention.

FIG. 5 shows an example of a PPF value map displayed on a display device of a patent portfolio management apparatus according to an embodiment of the present invention.

FIG. 6 shows an example of an annual fee payable amount simulation diagram displayed on a display device of a patent portfolio management apparatus according to an embodiment of the present invention.

FIG. 7 shows an example of a PPF-constituting applications schedule displayed on a display device of a patent portfolio management apparatus according to an embodiment of the present invention.

FIG. 8 shows an example of a graph showing a transition of patent registrations per year displayed on a display device of a patent portfolio management apparatus according to an embodiment of the present invention.

FIG. 9 shows an example of a hardware configuration of a network connection of a patent portfolio management apparatus according to an embodiment of the present invention.

FIG. 10 shows a flow chart for illustrating an operation of a patent portfolio management apparatus according to an embodiment of the present invention.

FIG. 11 shows a flow chart for illustrating another operation of a patent portfolio management apparatus according to an embodiment of the present invention.

FIG. 12 shows an example of a patent annual fee evaluation schedule displayed on a display device of a patent portfolio management apparatus according to an embodiment of the present invention.

FIG. 13 shows an example of an annual fee payment simulation chart displayed on a display device of a patent portfolio management apparatus according to an embodiment of the present invention.

FIG. 14 shows an example of a schedule for selection of individual patent displayed on a display device of a patent portfolio management apparatus according to an embodiment of the present invention.

FIG. 15 shows an example of a schedule for selection of corresponding foreign applications of PPF-constituting applications displayed on a display device of a patent portfolio management apparatus according to an embodiment of the present invention.

FIG. 16 shows an example of a variation of the PPF value map displayed on a display device of a patent portfolio management apparatus according to an embodiment of the present invention.

### DESCRIPTION OF EMBODIMENTS

The preferred embodiments of the present invention will be explained hereinafter in detail with reference to the drawings.

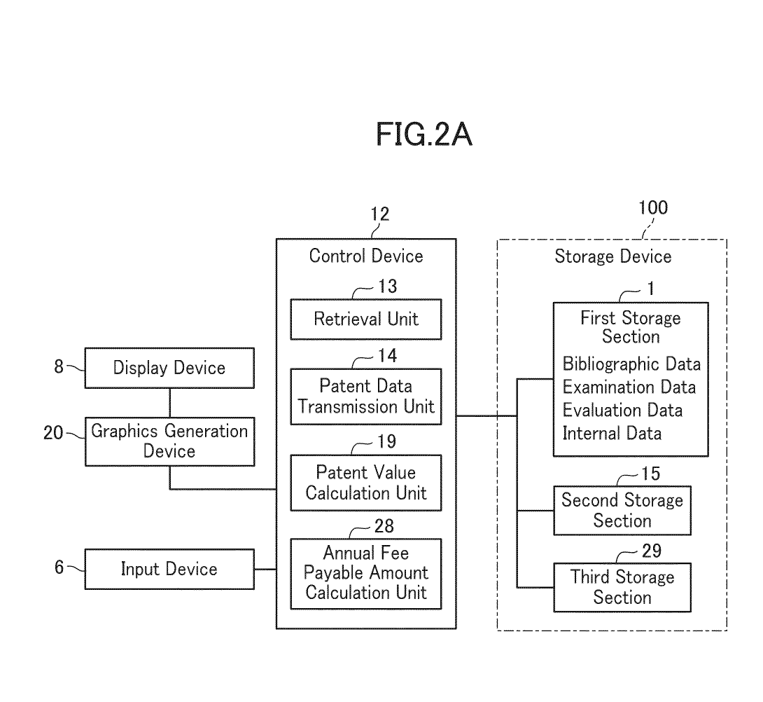

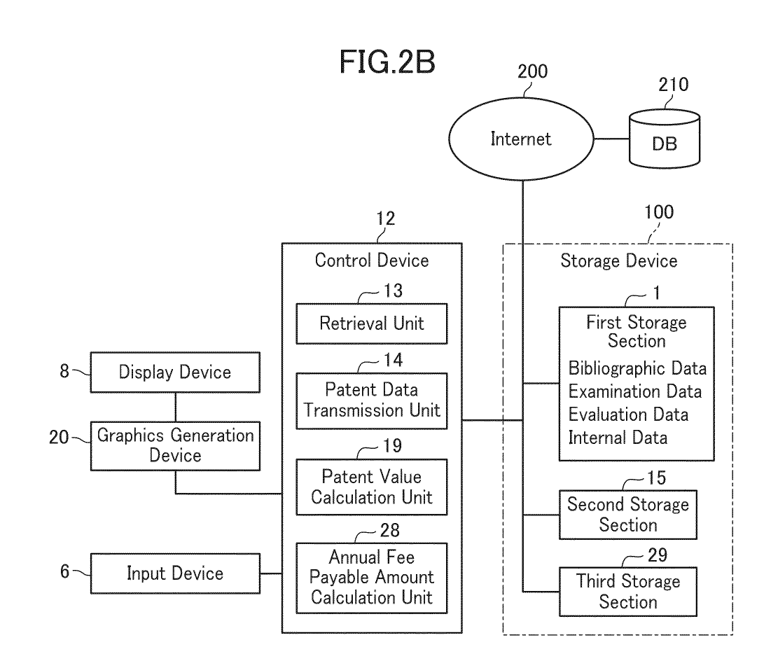

FIG. 2A shows a block diagram of a patent portfolio management apparatus according to an embodiment of the present invention.

A patent portfolio management apparatus includes a control device 12, a storage device 100, an input device 6 and a display device 8. The input device 6 is constituted by an information input device, such as for example, a keyboard, a mouse, a touch panel or the like. The input device 6 supplies an input signal to the control device 12. The storage device 100 includes a first storage section 1, a second storage section 15 and a third storage section 29, however the storage device may not necessarily be constituted by a single device. The storage device 100 may be constituted by a single device forming a collection of the first storage section 1, the second storage section 15 and the third storage section 29.

The first storage section 1, as will be explained hereinafter, stores therein a bibliographic data and the like, while the second storage section 15 temporarily stores therein a result of a retrieval or the like, and the third storage section 29 stores therein a patent annual fee table for each of the countries.

The storage device 100 is connected with the control device 12. The control device 12 reads from and writes to predetermined storage sections in the storage device 100.

Further, the control device 100 may be connected with external servers or databases through the internet.

The control device 12 includes a retrieval unit 13, a patent data transmission unit 14, a patent value evaluation unit 19 and an annual fee payable amount calculation unit 28. The display device 8 is connected to the control device through a graphics generation device 20.

To be more specific, the first storage section 1 has stored therein a bibliographic data related to an individual patent application. The bibliographic data is data published from the patent office of each of the countries. The bibliographic data includes, for example, an application number, which serves as a key, an filing data, an applicant name, a registration number, a registration data, an extinction data, an expiration due date, a filing nation (nation code), a priority claim date, number of claims, a patent classification and the like. Predetermined items of the bibliographic data are stored in the storage section 1 as an application data. When an evaluation is conducted, items required for calculation of an application value score are read out by the control device 12.

The application value score is indispensable for practicing the present invention. Items required for calculation of the application value score include a remaining period of patent term. A length of the remaining period of patent term affects a patent value score. So does a number of claims.

Other than the above-mentioned two items, the following items, which affects the application value score, can be stored in the first storage section 1: a number of independent claims, a number of specification pages, a number of inventions, a number of inventors, a number of applicants, a number of embodiments, a number of foreign filing countries, a number of divisional applications, a number of citing documents, a number of cited documents, whether or not examination request has been made, whether or not an accelerated examination request has been made, whether or not a preferential examination request is made, whether or not a domestic priority claim has been made, and the like. Other items can be added as necessary.

The first storage section 1 can be constituted by a storage section in a client personal computer, and in case of a large volume, the first storage section 1 can be constituted by a server connected through an in-house LAN (Local Area Network) or an external server connected through a network, such as for example, the internet. The first storage section 1 in the present embodiment is constituted by a server connected to the in-house LAN.

Further, the firs storage section 1 has a predetermined examination data stored therein. The examination data is sold or provide as an examination data of the patent office of each of the countries. Examples of the examination data include an examination request date, an issue date of office action, the provision stipulating the reason for rejection, documents cited in the examination, a response date for the office action (a submission date of remarks and amendments), a date of decision of rejection, a filing date of a request for trial, information of a trial decision, information of an opposition, a provision of information, information of a trial for patent invalidation and the like. From among the examination information, following are selected and stored in the first storage section 1: a number of notices of reasons for rejection, a number of documents cited in the examination, whether or not a trial against examiner's decision of rejection has been filed, whether or not an interview with examiner has been conducted, whether or not an opposition request has been filed, a number of oppositions filed, whether there has been a provision of information, a number of requests for inspection and the like.

Furthermore, examples of evaluation data for an individual application include a practice status by the corporation, an outlook for the practice by the corporation, a practice by a third party, a possibility for the practice by the third party, an importance of the invention (such as for example, an excellent invention, a basic invention, a peripheral invention and the like), necessity of foreign application filing, practicing products, an internal technology classification, a patent portfolio number (alternatively referred to as a patent group number), licensing information and the like. From among the evaluation information, following information required for annual fee management are selected and stored in the first storage section 1: a practice status by the corporation and the third party, the licensing information, the patent portfolio number and the like.

In the present specification, the term “patent portfolio” does not refer all of the applications and the patents owned by the applicant, but the term “patent portfolio” means a patent group constituted by a collection of groups of applications and patents mutually related with each other. Hereinafter, “patent portfolio” may alternatively be referred to as “PPF”. The term “patent” is not restricted to a patent right, but the term “patent” used in the present specification encompasses all kinds of intellectual property rights including not only the patent right but also a utility model right, a design right, a trademark right and the like.

Examples of corporation data include an invention reporting section, a patent owning section, an inventor section, a patent evaluation section, an evaluator, a person in charge of an intellectual property section. Necessary information from among the corporation information is selected and stored in the first storage section 1.

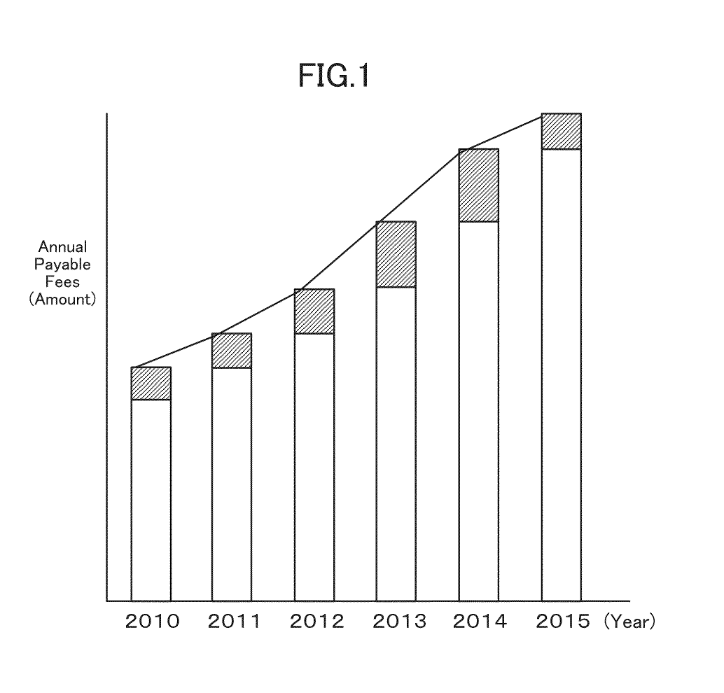

In addition, number of owning patents (applications) per each of past years, outlook of annual fee payable amount and number of future patents (applications) can be stored as the corporation data, so that a graph as shown in FIG. 1 can be drawn, thereby making it possible to learn a transition of patent annual fee payable amount.

The application data constitute by bibliographic data, the examination data, the evaluation data and the corporation data related to an individual application can be retrieved from the first storage section 1 by using the application number a retrieval key.

FIG. 2B shows a block diagram of a patent portfolio management apparatus according to another embodiment of the present invention. The patent portfolio management apparatus in the embodiment according to FIG. 2B differs from the patent portfolio management apparatus in the embodiment according to FIG. 2A in the point that the control device 12 is connected to a database 210 through an internet 200.

The database 210 can be constituted, for example, by a database of Japan Patent Office, a database of a patent office of other countries, a database accumulating periodically published patent information, or any database 210 of an external patent information provider.

The application data stored in the first storage section 1 needs to be successively updated, so that the control device 12 may be adapted to update the application data stored in the first storage section 1 by periodically taking in the published patent information from the database 210, for example through the internet 200 as shown in FIG. 2B. Further, the control device 12 may be adapted to have the application data stored in the first storage section 1 updated by the external patent information provider automatically and periodically with the information stored in the database 210.

Next, an example of an operation of the patent portfolio management apparatus according to an embodiment of the present invention will be explained.

The input device 6 is adapted to input items necessary for the patent annual fee management through a screen of a client personal computer. First, an application program for the patent portfolio management apparatus according to an embodiment of the present invention is activated by a keyboard or a mouse of the input device 6, so that a patent annual fee management screen is displayed through a predetermined menu screen.

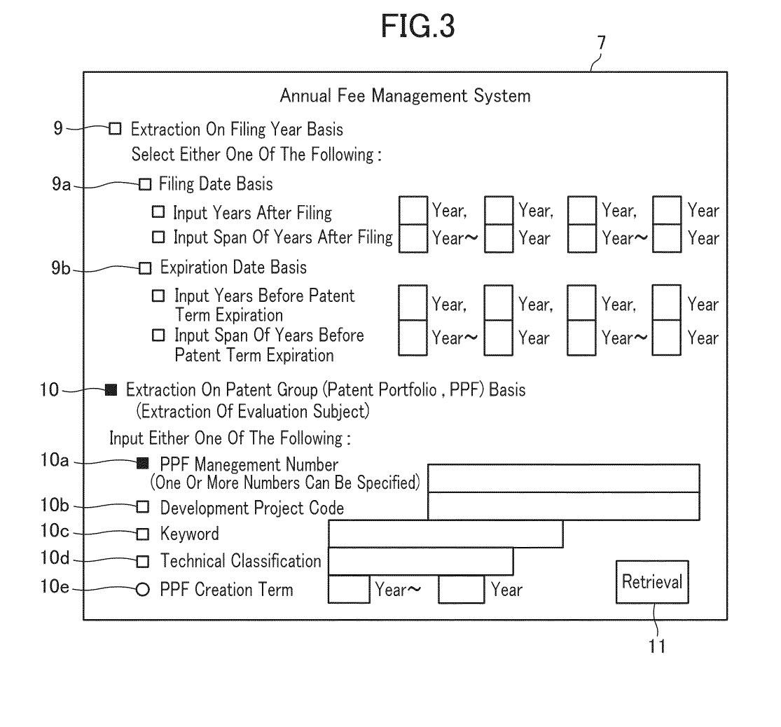

As a result of the operations necessary for the patent annual fee management, a screen 7 of a patent annual fee management system for the patent annual fee management as shown in FIG. 3 will be displayed on a display portion of the display device 8.

In the following description, an input screen and a display screen for displaying data retrieved as a result of the input are distinctively described as separate screens, but the input screen and the display screen can be simultaneously or separately displayed in one screen.

The screen 7 for the patent annual fee management as shown in FIG. 3 is an annual fee management system screen that extracts the subject applications for the evaluation. The screen 7 is divided into two major items, an “extraction on filing year basis” 9 and an “extraction on patent group (patent portfolio, PPF) basis” 10.

The major item “extraction on filing year basis” 9 is divided into two items: an item “filing date basis” 9a based on a filing date of the subject applications for evaluation; and an item “expiration date basis” 9b based on an expiration date of the patent term. Each of the items can be selected, for example, by moving a cursor of the input device 6 on the screen 7 to a void square check button, click the void square check button to reverse it into a blacked square check button, type in retrieval keywords in a blank input column to complete a retrieval data and depress a retrieval button 11. The square check button may be replaced by a radio button.

FIG. 3 shows a state of the screen 7 on which the major item “extraction on patent group (patent portfolio, PPF) basis (extraction of evaluation subject)” 10 and the item “PPF management number (one or more numbers can be specified)” 10a are selected.

However, in a case that the major item “extraction on filing year basis” 9 and the item “filing date basis” 9a are selected instead, a number of years elapsed after a filing year will be inputted next. For example, in a case that applications and patents fifteen years from the filing date are to be extracted, “15” is inputted in an input column of “input years after the filing” by a keyboard of the input device 6. In a case that applications and patents of a plurality of numbers of years after the filing, for example ten and fifteen years, are to be extracted, “10” and “15” are respectively inputted in input columns of the “input years after the filing”. In a case that applications and patents in a predetermined span of period after the filing, for example from fifteen years to seventeen years after the filing, “15” and “17” are respectively inputted in input columns of “input a span of years after the filing”.

In a case that the item “expiration date basis” 9b is selected, a number of years counted backward from the patent term expiration year is inputted next in a blank input column of the “expiration date basis” 9b. For example, in a case that all the patents five years from the patent term expiration year are to be extracted, “5” is inputted in a blank column in the right side of the “input years before the patent term expiration year”. In a case that patents of a plurality of numbers of years from the patent term expiration year such as five and two are to be extracted, “5” and “2” are respectively inputted in input columns of the “input years before the patent term expiration year”.

In a case that a span of a period before the patent term expiration is to be inputted, for example one to five years before the expiration of the patent term, “1” and “5” are respectively inputted in blank columns in the right side of the “input a span of years before the patent term expiration”, so that all the patents within five years before the patent term expiration can be extracted.

In a case that the major item “extraction on patent group (patent portfolio, PPF) basis (extraction of evaluation subject)” 10 is selected, there is a selective choice among four different ways of extraction: 10a, 10b, 10c and 10d explained hereinafter. In an extraction by the “PPF management number” 10a, in response to inputting one or a plurality of PPF numbers preliminarily known by a value evaluator, the PPF numbers are set as the retrieval key, so that the groups of patent group belonging to the specified PPF numbers are retrieved to be extracted as the subject for the evaluation.

In an extraction by a “development project code” 10b, a project code of research and development, which is preliminarily assigned to each of the applications and patents, is used for extraction of the subject applications and patents for the evaluation. A plurality of the project codes are allowed to be inputted hereto.

In an extraction by a “keyword” 10c, a technical keyword is inputted, so that a series of patent groups (groups of applications and patents) are extracted. A plurality of the technical keywords are allowed to be inputted hereto. An extraction by a “technical classification” 10d can be conducted in a similar way. In any cases, a series of patent groups (groups of applications and patents) technically related with each other can be extracted.

As can be understood from the foregoing description, how the applications and patents are grouped into groups of the applications and the patents constituting a patent portfolio can be left to the discretion of the users.

Further, in an extraction by a “PPF creation term” 10e, a creation term of the group of the applications an patents constituting a PPF can be specified, so that all the groups of the applications and patents in the term can be extracted. As mentioned above, the “PPF creation term” 10e can be inputted at the same time in addition to the one selective choice among 10a to 10d.

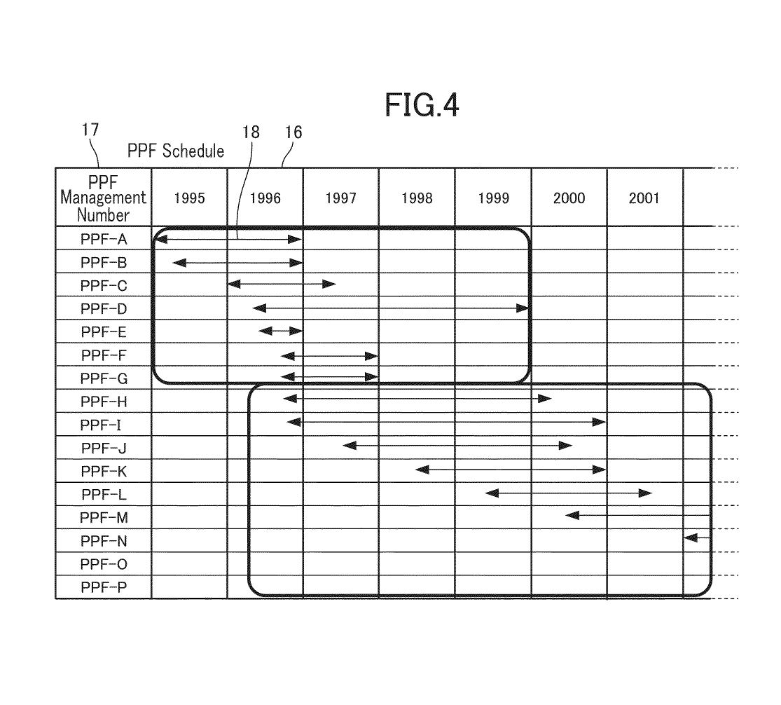

Explanation will be given hereinafter with reference to a PPF schedule shown in FIG. 4 as an example. The first storage section 1 of the storage device 100 has stored therein a PPF number, a PPF creation year and the like for data incorporated in the PPF schedule.

The FIG. 4 has a vertical axis representing the PPF number (PPF management number) 17 and a horizontal axis representing years of the PPF creation. To be more specific, PPF-A shows a group of the applications and patents constituting the PPF created in a period from the year 1995 to 1996, which is the PPF creation term indicated by an arrow 18.

Similarly, PPF-B shows a group of the applications and patents constituting the PPF created in a period from the first half of the year 1995 to 1996. Now, assuming that from the year 1995 to 1999 is selected as the creation term of each of the groups of the applications and patents in the PPF, the groups of the applications and patents constituting seven PPFs represented by PPF-A to PPF-G, as encompassed by a square bold line, will be the evaluation subject. Further, other groups of desired application and patents can be selected by means of other ways of extraction.

When the input on the input screen 7 of FIG. 3 is completed, the “retrieval” button 11 arranged on the right bottom corner of the screen is depressed.

In response to depressing the “retrieval” button 11, the retrieval unit 13 in the control device 12, referencing back to FIG. 2, searches the application data stored in the first storage section 1 based on the evaluation subject extraction criteria inputted by the input device 6, to extract the relevant groups of the application and the patents

Still further details of extracting the groups of applications and patents constituting PPFs will be explained hereinafter. No special contrivance is required in a case that the patent portfolio group is specifically shown when the PPF management number 10a, the development code 10b or the PPF creation term 10e is selected, because the patent portfolio is distinct in each of the items 10a, 10b and 10e.

On the other hand, however, in a case that the keyword 10c or the technical classification 10d is selected where a broad range of the evaluation subject is extracted crossing over groups of applications and patents, an automation is required to arrange lower concept groups included in each of the group of applications and patents. For instance, when “G03G” is inputted as an IPC classification for the item technical classification 10c, there are sub technical classifications such as “G03G15/” or “G03G21/” each constituting a lower concept of “G03G”, so that a preliminary editing arrangement is required to automatically divide the patent portfolio into a plurality of collections of patent applications. Each of the collections is a lower concept one level lower than the patent portfolio and is representing a group of applications and patents constituting the patent portfolio. Such preliminary editing arrangement enables an automatic extraction of the plurality of groups of applications an patents.

By having the above-mentioned function provided with the patent portfolio management apparatus, can it be possible to conduct a value evaluation of the groups of applications and patents constituting the patent portfolio, even for a corporation or an applicant having no experience of a patent portfolio management.

The patent data retrieved by the retrieval unit 13 is temporarily stored in the second storage section 15 constituting the patent information storage unit by the patent data transmission unit 14, together with various kinds of data associated with the applications of the patent data.

The foregoing embodiment is directed to a case in which the patent applications and the like necessary for the evaluation are retrieved from the first storage section 1 and the second storage section constituting the patent information storage unit which is a new patent evaluation database is generated. However, it is also possible to start an evaluation directly from the patent information storage unit having stored therein the subject applications for evaluation and the like focusing on the patent portfolio (PPF) only.

In this case, the input device 6 for inputting the retrieval criteria, the first storage section 1, the retrieval unit 13 and the patent data transmission unit 14 can be omitted.

A patent value score of each of the retrieved application is calculated by the patent value calculation unit 19 of the control device 12 simultaneously with an execution of the retrieval unit 13. The calculation of the patent value score can be accomplished by an existing patent analysis software title.

For example, “Patent Trading” (a trademark of Ocean Tomo, LLC), “Ultra Patent” (a trademark of Wisdomain Inc.), “Starvision” (a trademark of Nihon Unisis, Ltd.) and the like are commercially available. These commercially available software titles for patent analysis are adapted to calculate a patent value from published patent information respectively using its own unique analysis method.

These software titles for patent analysis are considered to be adapted to process the published patent information, to raise items such as a number of drawings, a number of independent claims, a number of patent classification codes, a number of inventors, a number of cited references, a number of reasons for rejection, a number of times referenced as a citation of reason for rejection, a number of opposition requests filed, a number of provisions of information and the like, to multiply an importance factor to the raised items and to normalize data as necessary so that the value scores are adjusted with time variation. In the present invention, these existing software titles as described above are to be used for calculation of the patent value scores. Therefore, a description of a calculation method of the patent value score will be omitted.

Next, after patent value score of each of the applications are calculated, the patent value calculation unit 19 sums up the calculated patent value scores per each of the groups of applications and patents constituting the patent portfolio, and calculates a total value score for each of the groups. At the same time, the patent value calculation unit 19 calculates an average value score by dividing the total value score by a total number of applications of the patent portfolio. The above-mentioned operation is performed per each of the extracted groups of the applications and patents.

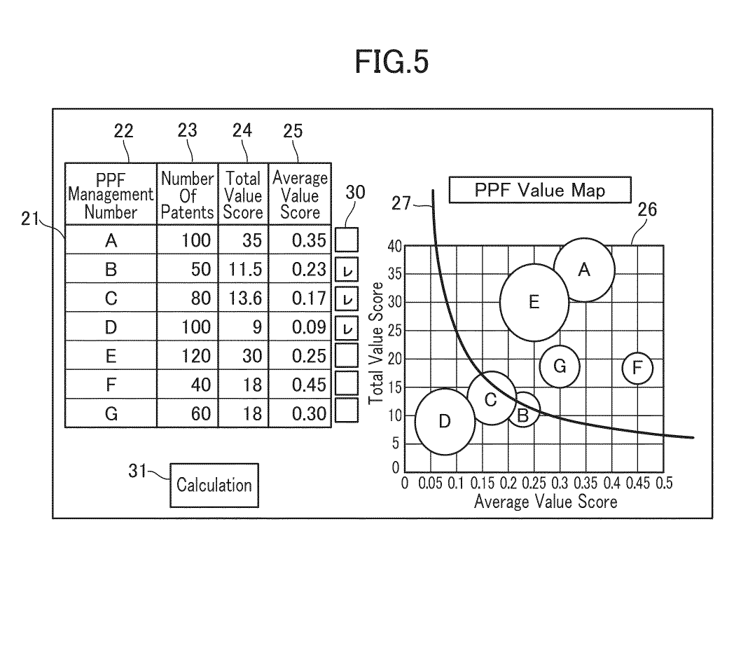

The patent value calculation unit 19 generates a schedule 21 including the calculation results to have a screen as shown in FIG. 5 displayed on the display device 8. The schedule 21 constitutes the patent value score. The schedule 21 is provided per each of the rows thereof with a PPF number column 22, a number of patents column 23, a total value score column 24 and an average value score column 25. The number of patents column 23 shows a figure representing a number of all the patent applications and patents that constitute a group of the applications and patents of the PPF. The total value score column 24 shows a total of the patent value score of each of the applications and the patents of the group of the applications and patents as described above. The average value score column 25 shows a value of the total value score of the PPF divided by the total number of the applications and patents of the PPF.

Further, as shown in FIG. 5, the screen of the display device 8 has a PPF value map 26 in the right side of the schedule 21. The PPF value map 26 is a representation of the digital data in the schedule 21 drawn in a form of a graph by the graphics generation device 20.

The PPF value map 26 has an x axis representing the average value score and a y axis representing the total value score. The PPF value map 26 shows circles each of which represents the group of the applications and patents identified by the PPF management number, the circle having a radius of a size in accordance with a relative number of the patents. The circles may have a variable magnification rate appropriately varied to minimize overlapping of the circles for easier recognition of each of circles on the PPF value map 26. The PPF value map 26 has a reference line 27 drawn therein.

To be more specific, the reference line 27 on the PPF value map is represented by a formula y=(a/x)+b, while a coordinate of the center of each of the circles representing each of the groups of the applications and patents in the PPF is represented by (xi, yi).

As can be understood from the foregoing description, the patent value scores are calculated, so that the schedule 21 is shown in the left side portion of the FIG. 5, while the graph of the PPF value map 26 is shown in the right side portion of the FIG. 5. The graph is generated by the graphics generation device 20. As described above, the PPF value map 26 shows the average value score of the group of the applications and patents on the horizontal axis and the total value score of the group of the applications and patents on the vertical axis. Each of the circles representing each of the PPFs having values calculated as described above is mapped in the graph. The size of the circle represents the number of applications and the patents of the group of the applications and patents, leading to the fact that the number of the applications and patents is reflected in the size of the radius.

The PPF value map 26 shown in FIG. 5 has each of the seven PPFs, PPF-A to PPF-G, mapped therein. “A” to “G” in each of the circles corresponds to PPF-A to PPF-G, respectively.

The curved reference line 27 in the graph is a reference line which can be set forth by a user. In the PPF value map 26 shown in FIG. 5, the reference line 27 is drawn to be represented by the formula y=(a/x)+b, where a and b are constants. However, the reference line 27 may instead be drawn to be represented by a formula y=(a/cx)+b, where a, b and c are constants, or a formula y=−ax+b, where a and b are constants.

For example, in the PPF value map 26 shown in FIG. 5, three groups of applications and patents PPF-D, PPF-C and PPF-B are mapped in the lower left portion of the graph with respect to the reference line 27, allowing a determination to be made that the three groups may be candidates for abandonment on the ground that the three groups are relatively low in value. Thus, the PPF value map can visualize a relative importance of each of the seven PPFs. This kind of graph can be drawn by commercially available software titles.

Further, the patent portfolio management apparatus according to the present invention allows the patent annual fee payable amount to be calculated in parallel with the aforementioned calculation of the patent value scores. The control device 12 shown in FIG. 2A or 2B issues a calculation instruction to the annual fee payable amount calculation unit 28. In the calculation mentioned above, the control device 12 utilizes a patent annual fee table for multiple countries stored in the third storage section 29 (or the annual fee information storage unit)

The patent annual fee table for multiple countries is accommodated therein with contents of patent annual fee system of each of major countries of patent such as Japan, the United States of America, Europe, China, Korea and the like. More specifically, the patent annual fee table for multiple countries accommodates annual fee payable amounts associated with years after the application or the years after the patent registration.

In Japan and the United States of America, the patent registration date forms a base line since the patent annual fee is payable after the patent registration, while in China (CN) and Europe (EP), the application filing year forms a base line since an application maintenance annual fee system is adopted in CN and EP. Thus, an annual fee calculation varies by country or region.

Hence, the control device 12 reads out from the second storage section 15 required information for annual fee calculation such as the application filing date, the patent registration and the like, and transmits the required information for annual fee calculation to the annual fee payable amount calculation unit 28. Subsequently, the annual fee payable amount calculation unit 28 matches the required information for annual fee calculation with the patent annual fee table stored in the third storage section 29, and calculates the annual fee payable amount. Next, the calculation of the annual fee payable amount will be explained hereinafter.

Taking a Chinese patent application for an example, now suppose that the Chinese patent application in the PPF-A falls on the seventeenth year from the application filing. The annual fee payable amount calculation unit 28 retrieves an amount of the annual fee for the seventeenth year from a Chinese patent annual fee table forming a part of the patent annual fee table for multiple countries. The amount of the annual fee thus retrieved constitutes an “annual fee payable amount for the current year”.

In this example, annual fee payment for four years, from the 17^{th} year to the 20^{th} year, is required until the expiration of the patent term, since in China the patent term expires twenty years after filing the application. Accordingly, the annual fee payable amount calculation unit 28 retrieves from the Chinese patent annual fee table the annual fee payable amount for each of the 17^{th} year to the 20^{th} year, and then sums them up to obtain the total amount, which constitutes a “the total payable amount of the annual fee”.

In the above-mentioned embodiment, the patent annual fee table for multiple countries in the third storage section 29 contains the patent annual fee tables of major countries only. However, the annual fee table in the third storage section 29 may contain all the annual fee tables of all the necessary countries and regions or may be restricted to a Japanese patent annual fee table only.

The amounts of patent annual fees of the countries are defined in unit of various kinds of currency such as dollar, euro or yen. For the benefit of total amount calculation, the annual fee table may be preliminarily registered therein with currency exchange rates so that all the amounts can be converted to yen.

Otherwise, the annual fee table may be registered with the amount in unit of the country rather than unifying all the amounts in unit of yen, so that the exchange rates are inputted with the latest exchange rates not shown in figures, thereby making it possible to calculate the annual fee in unit of a desired kind of currency, based upon the latest exchange rates. An explanation of input of currency selection and exchange rates is omitted.

Next, an annual fee management simulation conducted by the annual fee payable amount calculation unit 28 will be explained hereinafter. The annual fee management simulation teaches what change of the annual fee payable amount will result, for example, if the three groups of the application and the patents belonging to the three groups PPF-B, PPF-C and PPF-D as shown in FIG. 5 having relatively low patent value score are abandoned.

There are check boxes 30 respectively arranged on the adjacent right of the rows of the schedule 21 as shown in FIG. 5. For example, three check boxes 30 respectively in the right of the rows of PPF-B, PPF-C and PPF-D are marked as shown in FIG. 5.

In the above-mentioned explanation, the check boxes 30 are adapted specify the PPFs to be abandoned. However, the check boxes 30 may otherwise be adapted to specify the PPFs to be maintained.

After marking the three check boxes 30 as described above, a calculation button 31 arranged below the schedule 21 is depressed, so that the annual fee payable amount is recalculated. Marking the check boxes 30 and depressing the calculation button 31 can be done for example through a cursor movement on the screen or clicking by a mouse of the input device 6.

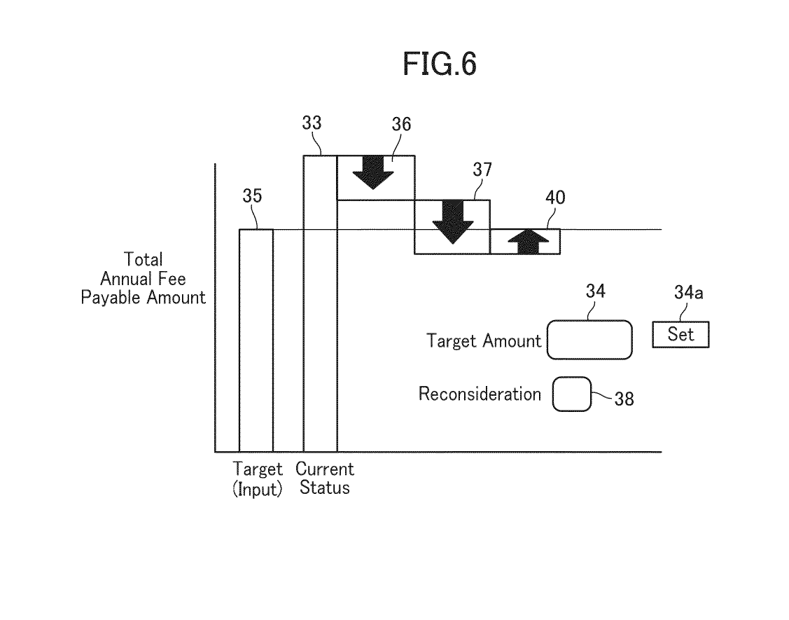

Next, the result of the recalculation of the patent annual fee payable amount is displayed on the display device 8 as a graph shown in FIG. 6. The graph has a vertical axis representing the total payable amount of the annual fee. The graph has a bar graph 35 and a bar graph 33 along its horizontal axis as shown in FIG. 6. The bar graph 35 shows a target amount, while the bar graph 33 shows the total amount of the annual fee of the patents currently owned by the corporation.

In the present embodiment, some groups of the applications and patents in the PPF are extracted, and the total payable amount of annual fee for all the extracted groups of the applications and the patents is shown.

The bar graph 35 showing the target amount is displayed as a result of inputting the target patent annual fee to be paid by the corporation in a target amount input column 34 and thereafter depressing a target setting button 34a. The patent portfolio management apparatus according to the present invention may be so adapted that the target amount is inputted separately, rather than being inputted on this screen.

A result of the input intended to abandon the groups of the applications and patents belonging to PPF-B, PPF-C or PPF-D is reflected in a reduction amount 36 as shown in FIG. 6. This is a result of the first simulation. The result is indicating a fact that the patent annual fee payable amount is still larger than the target payable amount even though the reduction amount 36 is reduced, leading to a determination that further reduction is necessary.

Now, getting back to FIG. 5, the check box 30 for PPF-G is checked and the calculation button 31 is depressed, so that the group of the applications and patents belonging to PPF-G, having a next lowest value than PPF-B, PPF-C and PPF-D, are abandoned.

The check box 30 and the input device 6 collectively constitute a patent portfolio selection unit.

The calculation result is shown in FIG. 6. In FIG. 6, the calculation result of the second simulation is displayed on the right side of the calculation result of the first simulation. To be more specific, the calculation result of the second simulation is shown by a bar graph 37 which extends downward from the bottom side of the bar graph 36 showing the calculation result of the first simulation. The result indicates that the patent annual fee payable amount is considerably lower than the target amount.

In some cases, further reconsideration is determined to be necessary based on a judgment that the simulation result indicates too much reduction. Of course, the simulation can be terminated upon a judgment that no further reconsideration is necessary once the reduction amount is greater than a difference from the target amount.

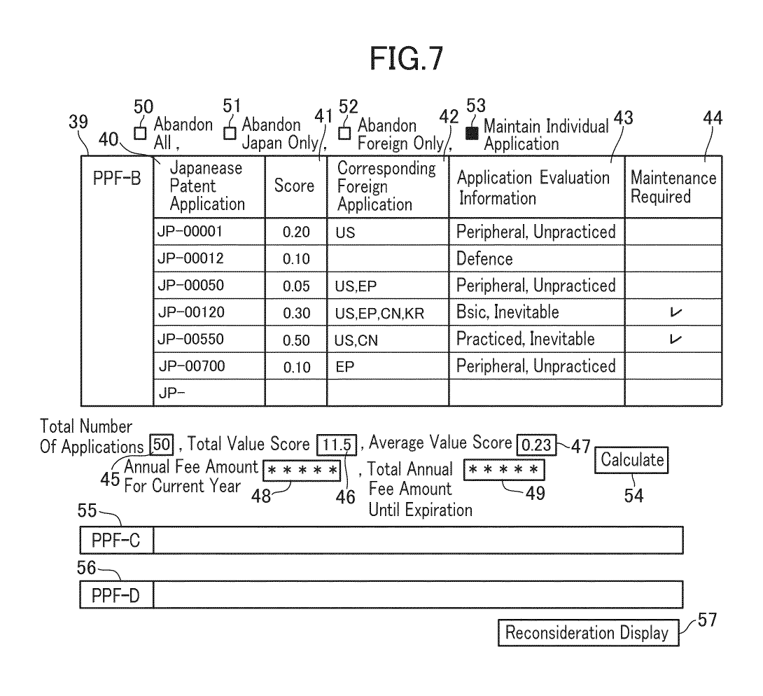

A case of another reconsideration will be explained hereinafter. In FIG. 6 a reconsideration button 38 is depressed, with the result that a breakdown of a group of the applications and the patents belonging to the PPF selected for the reduction is displayed as shown in FIG. 7.

An upper portion of FIG. 7 shows an applications schedule 39, which includes a column 40 showing an application number of Japan patent application, a column 41 showing a value score of the application, a column 42 showing a corresponding foreign application, a column 43 showing an application evaluation information and a column 44 showing whether or not the application is maintained.

Below the applications schedule 39 is displayed a column 45 showing a total number of applications in PPF-B. In the present example, the column 45 shows 50. On the right side of the column 45 is displayed a column 46 showing a total evaluation score of the PPF. In the present example, the column 46 shows the total value score 11.5 of PPF-B.

Further, on the right side of the column 46 is displayed a column 47 showing an average value score of the PPF. In the present example, the column 47 shows 0.23 as the average value score of PPF-B. Below the row inclusive of the columns 45, 46 and 17 is displayed a column 48 showing the annual fee amount to maintain the PPF for the current year. On the right side of the column 48 is displayed a column 49 showing a total amount of annual fees in the future to maintain all the patents constituting the PPF until the expiration of the patent term.

Furthermore, above the applications schedule 39 is arranged with columns to specify PPF, the application constituting the PPF, maintenance or abandonment of the patent. To be more specific, arranged from left to right are a selection column 50 for abandonment of all the applications and the patents, a column 51 for specifying abandonment of the Japan applications and patents Japan only, a column 52 for specifying abandonment of the foreign applications and patents only and a column 53 for specifying maintenance of an individual application or patent.

In FIG. 7, the column 53 for specifying maintenance of an individual application or patent is selected. The selection of the column 53 enables an input of the column 44 showing whether or not the application is maintained, which is the right-most column of the applications schedule 39. In the present example, maintenance of the two Japanese patent applications JP00120 and JP-00550 are specified. After completion of the input as described above, depression of a calculation button 54 causes the annual fee amount to be recalculated by the annual fee payable amount calculation unit 28.

This recalculation is intended to maintain the specified two Japanese patent applications and the corresponding foreign applications thereto, i.e., to maintain these two applications only in spite of abandoning PPF-B. The result of the recalculation is respectively displayed in the current year maintenance annual fee amount column 48 and the future maintenance annual fee total amount column 49.

The foregoing description is directed to a case in which PPF-B is selected to be abandoned. However, other PPFs, PPF-C and PPF-D, selected to be abandoned at the same time with PPF-B are displayed as a schedule 55 and a schedule 56, respectively. Here, display of PPF-G is omitted. A “reconsideration display” button 57 arranged in right bottom corner of the screen can be depressed to confirm the result of a series of reconsiderations.

Thereupon, the annual fee payable amount is recalculated by the annual fee payable amount calculation unit 28, so that the annual fee payable amount as a result of the reconsiderations is displayed as a bar graph 40 as shown in FIG. 6. As a result of the reconsiderations, the annual fee payable amount is confirmed to be the same with or in the vicinity of the target annual fee amount, thereby making it possible to terminate the series of patent evaluation operations for management of the annual fee payable amount.

Upon completion of the patent evaluation, patents to be maintained and patents to be abandoned are distinguished from each other, and the control device 12 outputs the evaluation result of the series of patent information for annual fee management, for example, to a host not shown equipped with a program having a function to make a payment instruction of the patent annual fee.

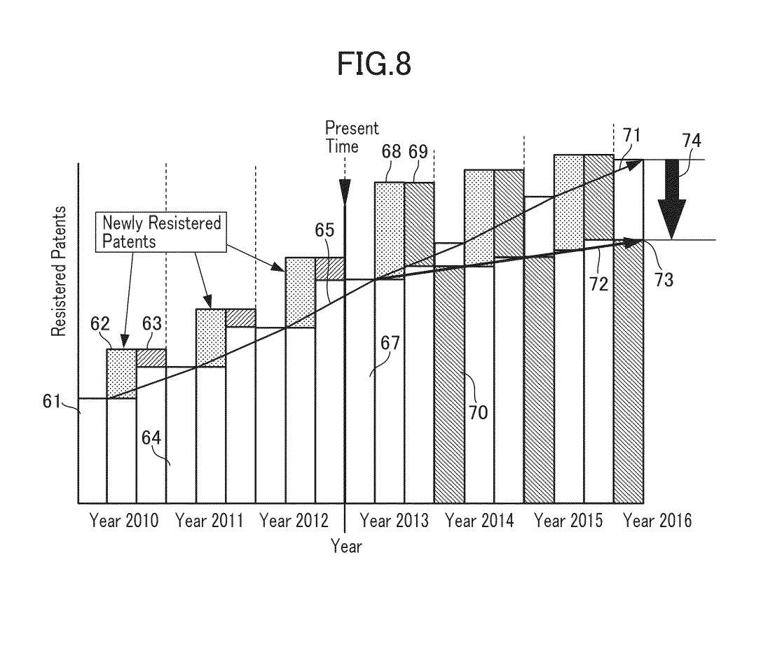

FIG. 8 is a graph showing a transition of patent registrations per year. The vertical axis represents a number of patent registrations, while the horizontal axis represents a year. Explanations will be made hereinafter with reference to FIG. 8.

A bar graph 61 shows a number of registered patents held at the beginning of the year 2010, while a shaded portion 62 on top of the bar graph 61 shows a number of patents registered anew in the same year and a hatched portion 63 shows a number of patents abandoned in the same year

The number of new registrations shown by the shaded portion 62 is added on top of the number of the patents held by the corporation at the beginning of the year 2010, but the number of patents abandoned as shown by the hatched portion 63 is subtracted, thereby determining the final number of patent registrations of the same year. This means that the final number of patent registrations for the year 2010 thus determined becomes a number of registered patents 64 held by the corporation at the beginning of the year 2011.

Hereinafter, new registrations and abandonments accrue in a similar way year by year until the year 2012, with the result that the registered patents owned by the corporation keep increasing year by year as shown by a curve 65.

Assume a case that the patent portfolio management method is used from the year 2013 as the current year. The number of registered patents owned by the corporation at the beginning of the year is as shown by the bar graph 67. The number of new registered patents of the year is shown by the bar graph 68, while the number of abandoned patents of the year is shown by the graph 69, so that the number of registered patents owned by the corporation at the end of the year is as shown by the bar graph 70.

A strategic abandonment can be realized as a result of setting forth the target number of patents to be abandoned as explained above, so that maintenance or abandonment is strategically determined through evaluation in unit of PPF, thereby making it possible to abandon unnecessary PPF patent groups in a large scale. By applying the method according to the present invention every year, the number of patents owned by the corporation can be suppressed to a slower increase as shown by a curve 72, compared to an increase as shown by a curve 71 according to a conventional method.

As a result, the number of patents owned by the corporation can be suppressed to a number as shown by a reference numeral 73 at the end of the year 2016. In comparison with the conventional method, the patent portfolio management method according to the present invention can cut the number of patents in a large scale as shown by an arrow 74, thereby making it possible to largely save the patent maintenance annual fee.

In the above description of the embodiment, the first storage section 1 stores therein four kinds of patent related data. However, the first storage section 1 may be adapted to store therein only published data such as the bibliographic data and the examination data, in which case the applicant outsources the patent portfolio management to an external investigation agency.

This allows the corporation to apply the first embodiment based on the published data, so that the PPFs of the groups of applications and patents to be maintained or abandoned are determined, thereby making it possible to identify the individual applications and patents to be maintained from among the groups of applications and patents thus determined to be abandoned. The applicant corporation that outsourced the patent portfolio management can receive a PPF evaluation result analyzed by the external investigation agency, so that the evaluation data and the PPF evaluation is reconsidered by an internal computer system using the internal data owned in the corporation, thereby making it possible to confirm the groups of the applications and patents that should truly be abandoned.

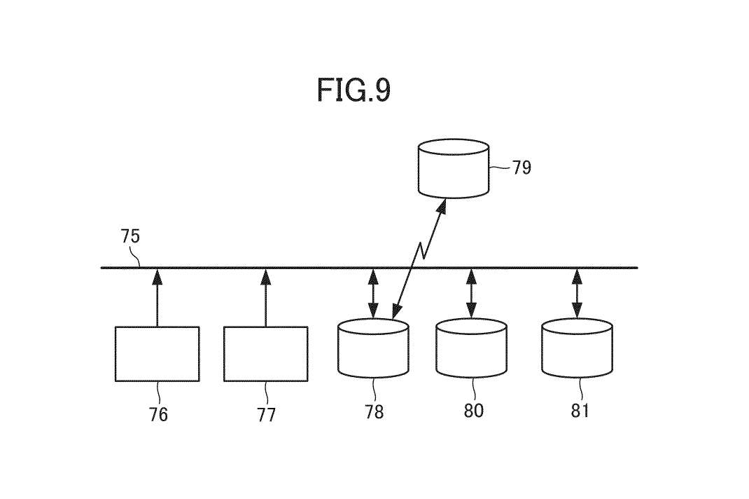

FIG. 9 is a hardware configuration of a network connection of the patent portfolio management apparatus shown in FIG. 2A or FIG. 2B.

A reference numeral 75 represents a network, specifically, an internal LAN or the like. A client 76 is connected with the input device 6 and the display device 8. A host 77 is constituted by for example a mainframe computer or a server of an enterprise system, in which all internal data of the patent applications is stored. The first storage section 1 is provided in the host 77.

An annual fee management server 78 is provided therein with the control device 12, the retrieval unit 13, the patent data transmission unit 14, the patent value calculation unit 19, the annual fee payable amount calculation unit 28 and the graphics generation unit 20. An annual fee server 80 has therein the annual fee tables of all the necessary countries 29. A server 81 is provided therein with the second storage section 15. In this embodiment, the server 81 is an independent server, however the server 81 may otherwise be integrated in the annual fee management server 78.

The patent annual fee information for the countries, constituted by the annual fee tables of the countries 29, stored in the annual fee server 80 is adapted to be incorporated with an external patent annual fee information for the countries 79 by the annual fee management server 78 through the internet. However, the annual fee tables of all the necessary countries 29 may otherwise be adapted to be manually updated with a latest information.

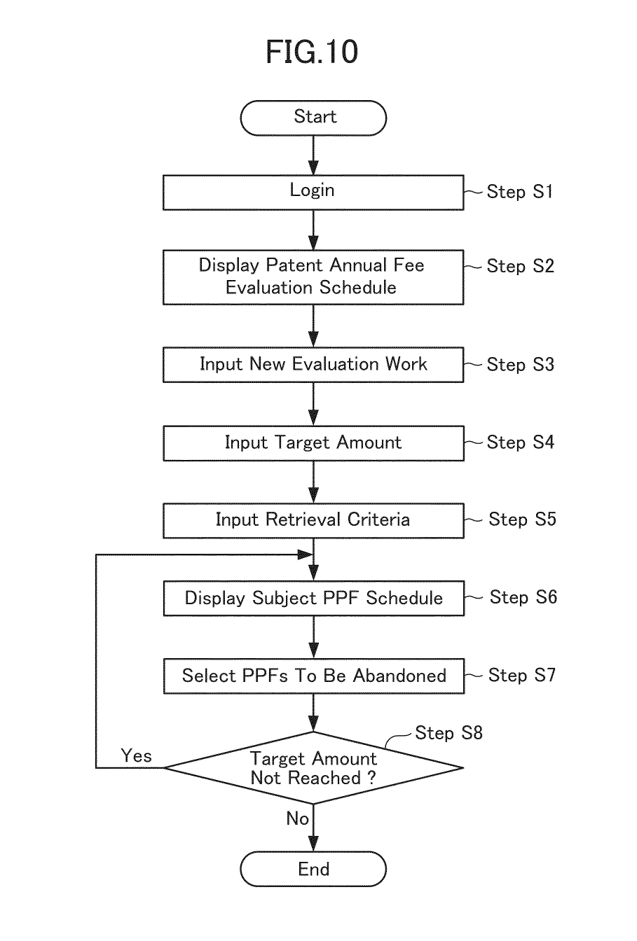

Entire flow of operations of the embodiment of the patent portfolio management apparatus according to the present invention will be explained hereinafter with reference to the flow chart of FIG. 10.

FIG. 10 shows a flow chart for illustrating an operation of a patent portfolio management apparatus according to an embodiment of the present invention.

First, to activate the present system, the control device 12 ensures that an ID and a password are inputted on a login screen not shown displayed on the client 76, and the use is logged in to the annual fee evaluation management system (Step S1).

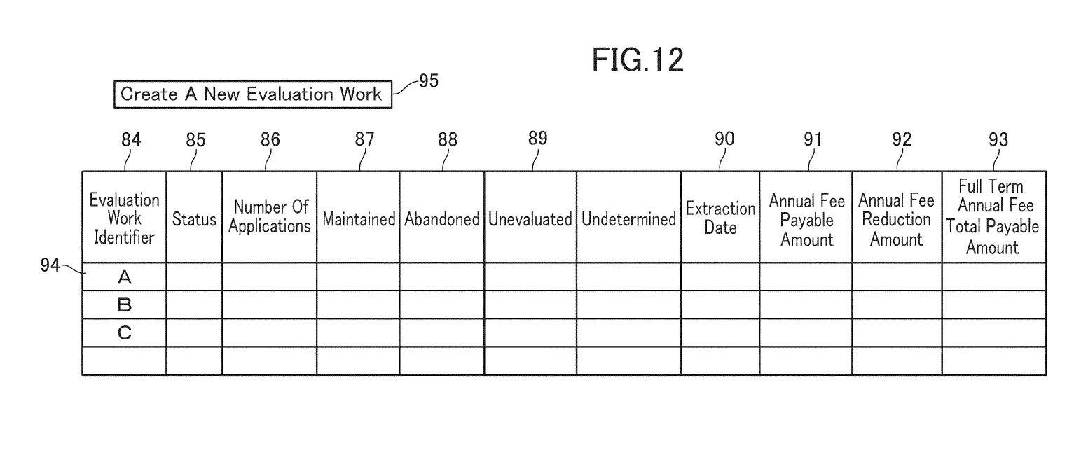

Thereupon, the control device 12 has a patent annual fee evaluation schedule shown in FIG. 12 displayed on the display device 8 (Step S2). As shown in FIG. 12, the display device 8 is displayed with a schedule showing past patent annual fee evaluation results. Items shown in the schedule include, from left to right: an evaluation wok identifier 84, an evaluation state 85, a number of applications 86, maintained 87, abandoned 88, unevaluated or undetermined 89, an extraction date 90, an annual fee payable amount 91, an annual fee reduction amount 92 and a full term annual fee total payable amount 93.

The evaluation work item 84 can be decoded with the year and which evaluation (first, second etc.) of the year, for example, the second evaluation in the year 2012 is decoded with “2012-2”. The evaluation work item 84 may otherwise be decoded by any other way of expression defined by the user.

The valuation state 85 indicates whether the evaluation work is “completed” or “under way”. Even in a case a new evaluation work is started, a previous evaluation work may still be underway. The number of applications 86 represents a number of all the subject patent applications (including those registered) for the evaluation work.

The maintained 87 is adapted to display a total number of the applications and the patents maintained as a result of the evaluation, while the abandoned 88 is adapted to display a number of the applications and the patents abandoned as a result of the evaluation. The unevaluated or undetermined 89 represents a number of the applications and patents yet to be evaluated where the evaluation work is underway.

The extraction date 90 displays a date the annual fee evaluation subject extraction is conducted. The annual fee payable amount 91 represents the annual fee payable amount necessary to maintain the applications and the patents as displayed by the maintained 87, while the annual fee reduction amount 92 represents the annual fee payable amount saved by abandoning the application and the patents as displayed by the abandonment 86.

The full term annual fee total payable amount 93 represents a total annual fee payable amount to maintain the rights to be maintained until the expiration of the rights. FIG. 12 shows that there have been three evaluation works A, B and C conducted in the past.

A record of the past annual fee evaluation works can be a reference for annual fee evaluation works to be conducted in the future. This kind of record can be stored in the first storage section 1 of FIG. 2A or FIG. 2B, to be more specific, in the internal data.

The screen shown in FIG. 12 has on its upper left portion provided with a new evaluation work generation button 95. Upon depression of the button, the control device 12 starts the new evaluation work (Step S3).

Upon start of the new evaluation work, the control device 12 executes a process associated with an input of the target amount (Step S4), and consequently a process associated with an input of the extraction criteria (Step S15). In these steps, the screen as shown in FIG. 3, already explained, is displayed. Explanation of FIG. 3 is omitted here because FIG. 3 has already been explained. The present example will be explained with an assumption that the “extraction on patent group (patent portfolio, PPF) basis” 10 and the “PPF creation term” 10e are selected.

It is further assumed that the “PPF creation term” 10e is so inputted that old PPFs generated in the duration of five years from 1995 to 1999 in the schedule as shown in FIG. 4 are extracted. Upon depression of the retrieval button 10 after the input of the PPF creation term as explained above, the retrieval unit 13 of the control device 12 extracts the seven PPFs from PPF-A to PPF-G. The control device 12 then displays the seven PPFs thus extracted in forms of the extracted PPF schedule 21 and the PPF value map 26 as shown in FIG. 5.

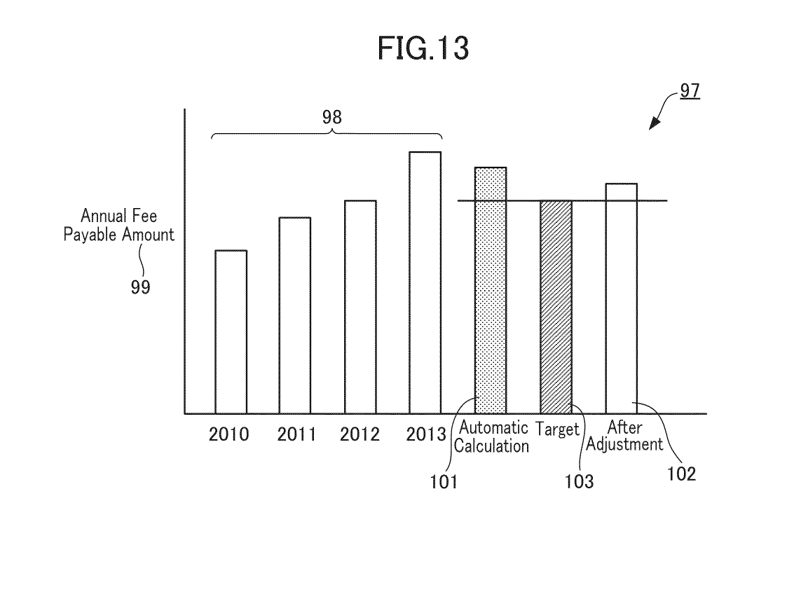

At the same time, the control device 12 displays an annual fees payment simulation 97 as shown in FIG. 13 on the display device 8. In order that the extracted PPF schedule 21 and the PPF value map 26 as shown in FIG. 5 and the annual fees payment simulation 97 as shown in FIG. 13 are displayed together with each other, the annual fees payment simulation 97 as shown in FIG. 13 may be displayed in reduced size in the screen as shown in FIG. 5, or a pop-up button can be further provided on the screen as shown in FIG. 5, depression of the pup-up button causing the pop-up window to show up. The manner of displaying may be left to the user's own discreet.

Four bar graphs 98 displayed on the left side portion of FIG. 13 show a transition of the patent annual fee payable amount from the year 2010 to the year 2013. However, the patent portfolio management apparatus according to the present invention may otherwise be adapted to show the transition of the patent annual fee payable amount for more years, for example, ten years in the past.

The patent annual fee payable amount per each of the years can be stored the first storage section 1, to be more specific, in the internal data, so that the annual fee payable amount in the past from the year 2010 to the year 2013 are displayed in the graph as shown in FIG. 13.

Next, another embodiment will be explained hereinafter. In the previous embodiment, the user manually selects PPF-B, PPF-C and PPF-D having relatively lower value to be abandoned while browsing the PPF value map 26 as shown in FIG. 5, while in the present embodiment, which is a variation from the previous embodiment, the patent portfolio management apparatus is so programmed to automatically select PPF-B, PPF-C and PPF-D, which are positioned lower left with respect to the reference line 27, to be determined as a subject for abandonment.

For example, the patent portfolio management apparatus according to the present embodiment may be so adapted that the control device 12 compares the total evaluation score or the average evaluation score of each of the PPFs with the total evaluation score or the average evaluation score of the reference line 27 at a corresponding position on the reference 27, and determines the PPFs having a lower total evaluation score or a lower average evaluation score than the value of the reference line 27 to be a subject for abandonment. In this embodiment, the annual fee payable amount can be automatically calculated and displayed.

The result is the annual fee payable amount automatically calculated as shown in a bar graph 101 in FIG. 13. To be more specific, the annual fee payable amount thus automatically calculated indicates the annual fee payable amount in a case that PPF-B, PPF-C and PPF-D are abandoned.

Returning to the first embodiment, in response to the extraction of the evaluation subject by the retrieval unit 13 of the control device 12, the screen as shown in FIG. 6 is displayed. On this screen, the total annual fee payable amount of all the extracted PPFs is displayed by the bar graph 33 as a current status. In response to inputting the target amount in the input column 34 and thereafter depressing the target setting button 34a on this screen, bar graph 35 showing the decreased target annual fee payable amount is displayed on the left hand side of the bar graph 33 showing the current status. Thereupon, the control device 12 executes a process associated with the inputted target amount (Step S4).

Next, the control device 12 executes a process associated with the inputted extraction criteria (Step S5) and the extracted PPF schedule and the PPF value map as shown in FIG. 5 (Step S6).

Upon the selection of the PPFs to be abandoned on the screen as shown in FIG. 5, the control device 12 executes a process associated with the selected PPFs o b abandoned (Step S7). In this example, PPF-B, PPF-C and PPF-D are selected by checking (intended for abandoning) the corresponding checkboxes 30, and the calculation button 31 is depressed.

Thereupon, the control device 12 and the graphics generation device 20 display the screen as shown in FIG. 6 on which the reduction amount by abandoning PPF-B, PPF-C and PPF-D is displayed as the bar graph 36. As a result, the total annual fee payable amount is known not to have reached down to the initially set target amount 35. The control device 12 executes a process for decision of an unreached target amount (Step S8).

The decision logic as explained above can be achieved by having a computer make a decision by comparison between the target amount and the payable amount after the reduction. To be more specific, the decision logic can be achieved by having the control device 12 as shown in FIG. 2A or FIG. 2B provided therein with a comparison unit and a decision unit. In case that the target amount is unreached (YES in step S8), the decision logic returns to the step S6 again to have the PPF to be abandoned further selected. This loop of the process will be iterated until the target amount is reached to exit the loop and finish the flowchart of FIG. 10.

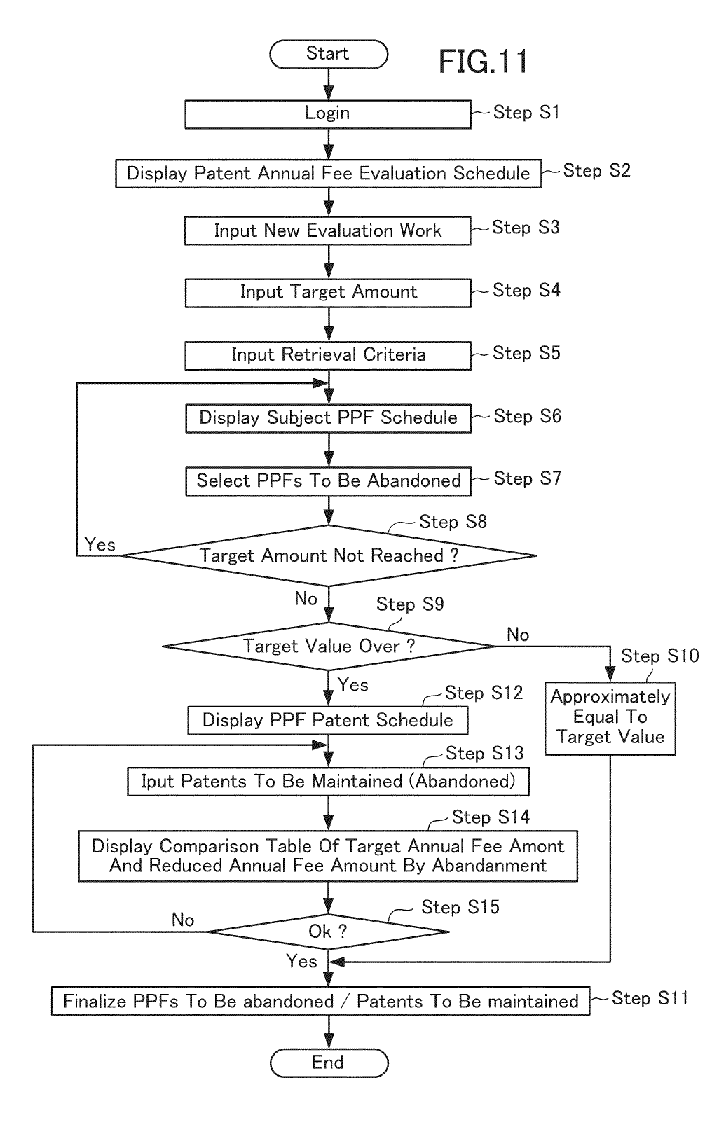

FIG. 11 shows a flow chart according to another embodiment of the present invention.

Specifically, the method shown in FIG. 11 is a flowchart for a case in which the total annual fee payable amount of the PPF to be abandoned is over the target amount.

There is a case in which any more PPF to be abandoned is not found. In such a case, the reconsideration button 38 in FIG. 6 can be depressed so that the target amount can be changed. Instead of depressing the reconsideration button 38, the target amount column 34 can be directly inputted with a new target amount so that an iteration step can be terminated. Of course, needless to say, a button for terminating the iteration step can be further arranged on the screen.

In the flow chart of FIG. 11, description of the flow until the step 8 is similar to that of FIG. 11, so that it will be omitted here.

Thereafter, in step 9, the control device 12 determines whether or not the target amount is largely exceeded in the case that the target amount is reached. The user may preliminarily define criteria of “largely exceeded”. For example, “largely exceeded” can be defined to indicate a state that an amount of difference exceeds 10% or 5% (allowable amount range), so that whether or not the target amount is largely exceeded can be automatically determined by a computer.

This can be achieved by paving the control device 12 as shown in FIG. 2A or FIG. 2B provided therein with a comparison and determination program. However, in a case that the user desires to override a result of the determination by a machine rather than following the determination by the machine, so that the amount be further decreased, the user can return to the step 4 for inputting the target amount, where a revised target amount can be inputted. The patent portfolio management apparatus according to the current invention can be so constructed that upon the input of the revised target amount, steps 6 to steps 8 are automatically executed again.

If the total annual fee payable amount is approximately equal to the target amount or within the allowable amount range (NO in step S9), the total annual fee payable amount is determined to be approximately equal to the target amount (Step S10), and in this case a process to finalize the PPFs to be abandoned and the patents to be maintained is executed (Step 11), and the evaluation work is finished. Needless to say, by the aforementioned process, an after adjustment bar graph 102 in FIG. 13 will be approximately as tall as a target amount bar graph 103, although not shown as such in FIG. 13.

Next, if the reduction amount exceeds the allowable amount range (YES in step S9), the control device 12 displays a PPF patent schedule as shown in FIG. 7 on the screen (Step S12).

The patent portfolio management apparatus according to the present invention may otherwise be adapted to allow the use to determine that the target amount is not exceeded, rather than to force the user to follow the determination made by the machine as to whether the target amount is exceeded or not. In this case, the patent portfolio management apparatus according to the present invention may be further provided with a forced execution button not shown, so that step S10 and step S11 are sequentially executed upon depression of the forced execution button.

For example, it may be possible to determine whether or not there is any valuable patent included in PPF-B by a schedule of patents in PPF-B displayed on the screen as shown in FIG. 7. For example, in a case the “Abandon Japan Only” 51 is selected, the foreign applications are to be maintained, while in a case the “Abandon Foreign Only” 52 is selected, the Japanese application is to be maintained. In case the “Maintain Individual Application” 53 is selected, the “Maintenance Required” column 44 turns to accept an input, so that the individual application can be specified to be maintained by checking the “Maintenance Required” column 44.

Thus, it is possible to identify individual patents to be exceptionally maintained from among the patents included in the PPF selected to be abandoned, through an input on the screen as shown in FIG. 7, upon which the control device 12 executes a process associated with the input (Step S13). In this example, Japanese applications JP-00120 and JP-00550 are selected and the corresponding foreign applications are to be maintained together. In response to a calculation button 54 being depressed, the annual fee payment amount calculation unit 28 calculates the annual fee amount again.

The annual fee thus recalculated is reflected to the current year maintenance annual fee amount column 48 and the future maintenance annual fee total amount column 49.

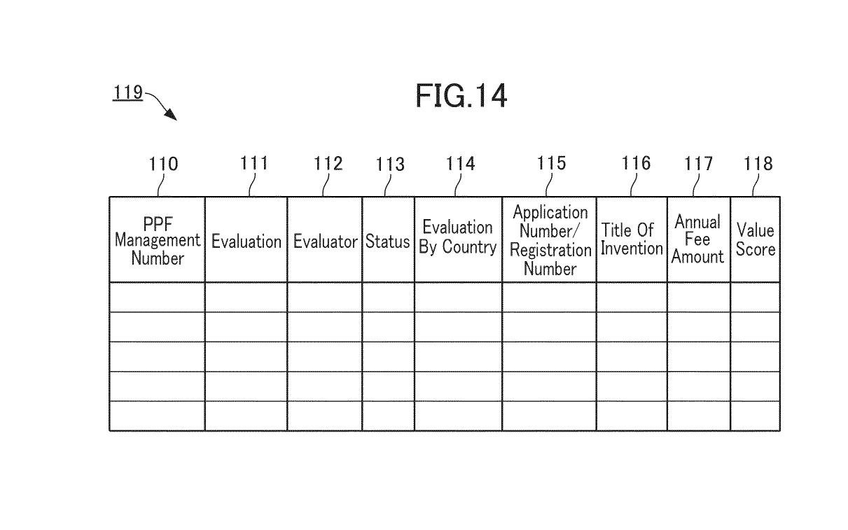

Next, a screen for specifying individual patents to be selected will be explained hereinafter. FIG. 14 shows a schedule 119 having columns from left to right: PPF management number column 110, evaluation column 111, evaluator column 112, status column 113, evaluation by country column 114, filing number / registration number column 115, title of invention column 116, annual fee amount 117 column and value score column 118.

Upon selection of one of PPFs not shown, the Japanese patents constituting the selected PPF are displayed in the schedule 119. One or more of the patents to be maintained are selected based on the information displayed in the schedule 119. The filing number / registration number column 115 is set active to allow the patents to be selected. The applications or the patents to be maintained can be selected by inputting a check mark in the column 115 or by depressing the column 115 to have the column 115 highlighted by reverse display

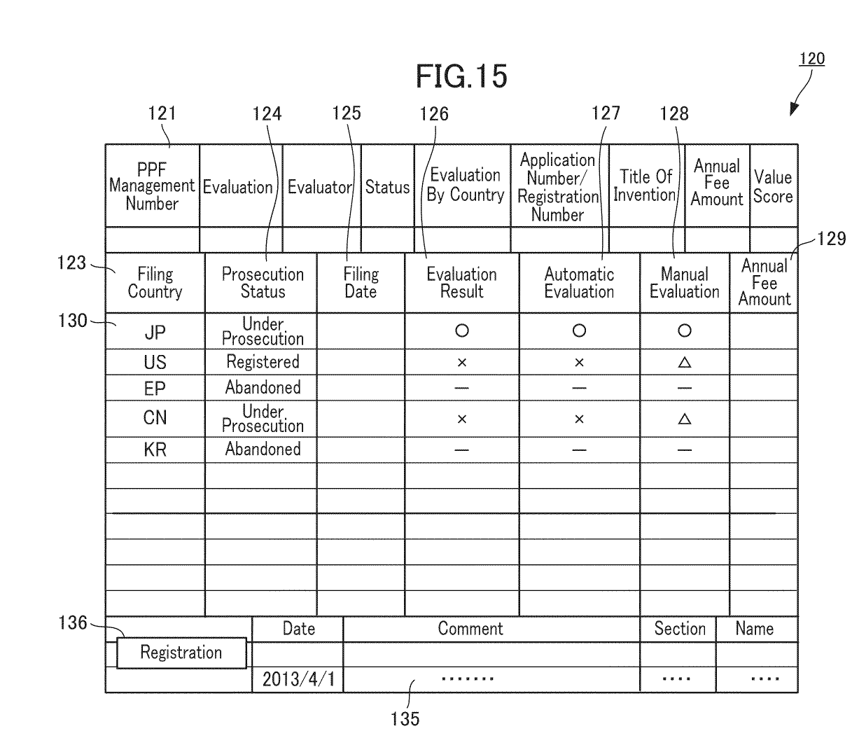

In response to thus selecting of an application or a patent, information 120 inclusive of corresponding foreign applications as well as the Japanese application or patent is displayed on the screen as shown in FIG. 15. Output items of the information 120 include, from left to right, filing country 123, prosecution status 124, filing date 125, evaluation result 126, automatic evaluation 127, manual evaluation 128 and annual fee amount 129. All of the applications or patents in patent family 130 stemming from the Japanese application or patent are displayed in a column of the filing country 123.

FIG. 15 shows prosecution status in five countries, one application or patent per each of the countries. However, in case there is a divisional application, a continuous application or the like in a country, such application is also displayed as well. The application or the patent with the prosecution status 124 indicating existence of no right any more is not a subject of annual fee payment. Therefore, the patent portfolio management apparatus according to the present embodiment is adapted to exclude such application or patent from the subject of annual fee calculation and evaluation.

In FIG. 15, non-existence of the application or the patent can be recognized by display of bar marks in columns 126 to 128 thereof. In the table 120, only the evaluation result column 126 is active to allow input thereto. Results of the automatic evaluation 127 and the manual evaluation 128 can be seen as a reference.

On the bottom of the table 120 are provided with a date column showing the date on which the evaluation result is inputted, a comment column 135 for inputting a reason for reconsideration why this patent is restored, a section column of the evaluator and a name column of the evaluator. The section and the name of the evaluator can be inputted by the evaluator, but in case that the evaluator is preliminarily requested to conduct the evaluation, the section and the name of the evaluator may preliminarily set therein to be displayed. Reconsideration (restoration) can be completed upon depression of a registration button 136 after input of the table 120.

On the top of the table 120 are displayed a PPF management number column 121 for displaying the selected PPF management number, and items 111 to 118 corresponding to the PPF management number in the schedule 119 shown in FIG. 14.

Upon the input of the patents to be maintained and the recalculation of the annual fee amount, the control device 12 displays a comparison table of the target annual fee amount and reduced annual fee amount by the abandonment on the display device 18 (Step S14). The bar graph 40 in FIG. 6 visualizes the restored annual fee amount, thereby making it possible to visually recognize that the total annual fee payable amount 40 is approximately equal to the target amount 35.

Similarly, the after adjustment bar graph 102 in FIG. 13 may become as tall as the target amount bar graph 103, upon the input of the patents to be maintained and the recalculation of the annual fee amount. The patent portfolio management apparatus according to the present embodiment may display either one of the graph of FIG. 6 or the graph of FIG. 13 in this case. However, in this example, the graph of FIG. 6 may be preferable, because the graph of FIG. 6 indicates a variation of the annual fee amount per each of the simulation steps.

When either one of the graph of FIG. 6 or the graph of FIG. 13 is displayed on the display device 8, the control device 12 determines whether or not the annual fee payable amount after the reconsideration is approximately equal to the target amount or within the allowable amount range (Step S15). This determination is also an automatic determination by the computer. In a case of failure in restoration to the target amount (NO in step S15), the process returns to the step S13 so that further patents to be restored (maintained) are selected. This loop of the process is iterated until the annual fee payable amount after the reconsideration is approximately equal to the target amount or within the allowable amount range.

However, the patent portfolio management apparatus according to the present embodiment may otherwise be adapted to allow the user to make the above-mentioned determination at the step S15, rather than forcing the user to follow the determination by the computer, so that the steps S13 to S15 are iterated again or the process is forcibly moved to the step S11 upon the determination by the user which may be different from the determination by the computer. When the allowable amount range is reached (YES in step S15) the loop of the process is exited so that the process of finalizing the PPSs to be abandoned and the patents to be maintained is executed (Step S11).

Next, the third embodiment is explained hereinafter. In the above-mentioned embodiment, PPFs to be maintained are selected is the steps S1 to S8 where the annual fee payable amount and the like are simulated through calculations, and the steps S9, S10, S12, S13, S14 and S15 are executed if the total annual fee payable amount of the PPF to be abandoned is over the target amount.

However, the patent portfolio management apparatus according to the present embodiment is so adapted that if the step 8 is NO the process immediately moves to the step 11 to complete the process, rather than going through the long and complicated process of the steps S9, S10, S12, S13, S14 and S15, thus simplifying the operation of the patent portfolio management apparatus.

This means that the process is completed only by the iteration of the steps 6 to S8 where the PPFs to be abandoned are selected or re-selected. A flowchart of the present embodiment is omitted because it is the same as the flowchart shown in FIG. 11 excluded with the steps S9, S10, S11, S12, S13, S14 and S15.

Further, the fourth embodiment is explained hereinafter. In the first embodiment, the patent portfolio management apparatus is so constructed to display the screen as shown in FIG. 5 on which are simultaneously displayed the schedule 21, inclusive of the number of patents 23, the total value score 24 and the average value score 25 of the extracted patent portfolio management numbers 22 and the PPF value map 26, so that the user can select the PPFs to be abandoned. However, the patent portfolio management apparatus may otherwise be so constructed to have the computer automatically select the PPFs to be abandoned, rather than to allow the user to select the same.

To be more specific, the patent portfolio management apparatus is so constructed to automatically select the PPFs displayed in the left lower region with respect to the reference line 27 which is a hyperbolic curve represented by the formula y=(a/x)+b of FIG. 5 as the PPFs to be abandoned. This means that the patent portfolio management apparatus selects the PPFs having a lower total value score 24 or a lower average value score than other PPFs. The coordinate of the PPF is represented by (xi, yi).

The PPFs to be abandoned can be determined by setting the total value score 24 as the y axis coordinate (yi) and the average value score 25 as the x axis coordinate (xi) and comparing with the hyperbolic curve represented by the formula y=(a/x)+b. In other words, the patent portfolio management apparatus may select the PPFs having the coordinate (xi, yi) that satisfies y<(a/x)+b.

As can be understood from the foregoing description, the patent portfolio management apparatus may have the computer program automatically select the PPFs to be abandoned. However, the patent portfolio management apparatus may be so constructed to allow the user to specify the coefficient a and b of the formula y=(a/x)+b on the screen of FIG. 5, although not shown, so that the position of the reference line 27 can be adjusted, thereby making it possible to allow the user to increase or decrease the PPFs to be abandoned at his or her own discreet.

The result of selecting the PPFs to be abandoned can be confirmed by the graph as shown in FIG. 6. To be more specific, the graph allows the use to confirm whether or not the annual fee payable amount is moved close to the target annual fee amount 35. In a case that the target is not reached so that further PPFs need to be abandoned, the coefficient b of the aforementioned formula can be increased so that the PPFs to be abandoned are increased, thereby making it possible to decrease the annual fee payable amount. Thus, the patent portfolio management apparatus according to the present invention allows the user to conduct the simulation as explained above, so that an effective management work can be realized.

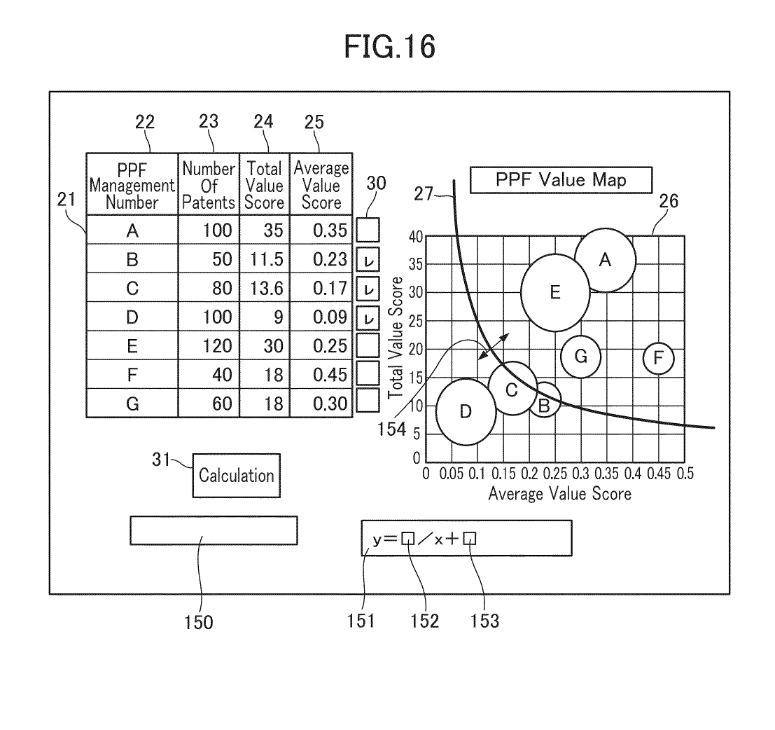

FIG. 16 shows an embodiment of the patent portfolio management apparatus having a screen inclusive of the schedule 21 and the PPF value map 26 based on the

PPF value map 26 of FIG. 5, further arranged to allow the use to adjust the position of the reference line 27. To be more specific, the screen has in its lower portion an input column 150 for setting a PPF value score reference value.

The position of the reference line 27 can be determined through inputting the PPF value score reference value in the input column 150.

FIG. 16 also shows the formula representing the reference line 27 in a PPF value score reference value input column 151 as another way of determining the position of the reference line 27. A constant value input column 152 and/or a constant value input column 153 can be inputted with an arbitrary value, so that the reference line 27 is moved vertically, horizontally or obliquely as shown by an arrow 154.

The patent portfolio management apparatus described above allows the patent portfolio group below the reference value to be extracted to have the annual fee payable amount therefor calculated. Further, the patent portfolio management apparatus described above constitutes a support tool for deriving an appropriate result through an annual fee payment simulation of repeatedly adjusting the PPF value score reference value until a desired annual fee amount is reached, in other words, until a reduced annual fee amount is reached.

### INDUSTRIAL APPLICABILITY

The present invention provides a computer-implemented support system capable of selecting the applications and the patents, constituting the PPF having a relatively low utilization value, as a subject of abandonment, for the purpose of appropriately managing and maintaining the patent portfolio, which is the patent asset constituted by the patent applications and registered patents owned by an individual or a corporation.

Further, the present invention can be applied in a field of a trustee service of an appropriate patent portfolio management.

### EXPLANATION OF REFERENCE NUMERALS

1 first storage section

6 input device

8 display device

12 control device 13 retrieval unit

15 second storage section

19 patent value calculation unit

20 graphics generation unit

21 schedule

26 PPF value map

27 reference line

28 annual fee payable amount calculation unit

29 third storage section

1. A patent portfolio management apparatus, comprising:
a patent information storage unit which stores therein patent-related information of patent applications and/or patents for an evaluation;
an annual fee information storage unit which stores therein an annual fee table containing information of annual maintenance fees for at least one country;
a patent value calculation unit which calculates a value score of each of the patent application and/or patents stored in the patent information storage unit in response to a patent portfolio value score output instruction inputted thereto;
an annual fee payable amount calculation unit which calculates a patent annual fee payable amount for a reference year of the patent applications and/or patents subject for the evaluation based on the annual fee table stored in the annual fee information storage unit in response to the patent portfolio value score output instruction;
a graphics generation device which generates a patent portfolio management screen inclusive of a preliminarily determined diagram or a preliminarily determined table in accordance with the value score and the patent annual fee payable amount, the value score being a score of a group of patent applications and/or patents having a predetermined relationship with each other to constitute a patent portfolio or a score of each of the patent applications and/or patents forming a part of the patent portfolio, the patent annual fee payable amount being an amount calculated by the annual fee payable amount calculation unit; and
a display device which displays the patent portfolio management screen generated by the graphics generation device.

2. The patent portfolio management apparatus as set forth in claim 1, further comprising:
an input device which inputs retrieval data for extracting the patent applications and/or patents subject for the evaluation as a patent portfolio group;
a first storage unit which stores therein application information and application evaluation information associated with each of the patent applications and/or patents, the application information including a bibliographic data inclusive of at least one of an application number, a filing date, a registration date, an expiration due date, a lapse date, and a priority date; and
a retrieval unit which retrieves the patent applications and/or patents subject for the evaluation from the first storage unit based upon the retrieval data inputted by the input device, wherein the patent information storage unit stores therein the patent-related information associated with the patent applications and/or patents subject for the evaluation retrieved by the retrieval unit.

3. The patent portfolio management apparatus as set forth in claim 1, further comprising:
an extraction unit which extracts a patent portfolio having a predetermined value score based upon the value score calculated for each patent portfolio; and
a control device which controls the annual fee information storage unit so as to calculate the patent annual fee payable amount for the reference year of each of the patent applications and/or patents constituting the patent portfolio extracted by the extraction unit, and to have the patent annual fee payable amount outputted on the patent portfolio management screen.

4. The patent portfolio management apparatus as set forth in claim 1, wherein the input device inputs a patent maintenance request or a patent non-maintenance request per the patent portfolio or per each of the patent applications and/or patents on the patent portfolio management screen displayed on the display device, and the control device controls the annual fee payable amount calculation unit for the reference year based upon the patent maintenance request or the patent non-maintenance request inputted by the input device, and has a calculation result of the annual fee payable amount be outputted on the patent portfolio management screen.

5. The patent portfolio management apparatus as set forth in claim 1, wherein the annual fee payable amount calculation unit further calculates a total annual fee payable amount from the reference year up to a patent term expiration.

6. The patent portfolio management apparatus as set forth in claim 4, further comprising:
a patent portfolio selection unit to select one or more groups of the patent applications and/or the patents constituting the patent portfolio on the patent portfolio management screen having the patent annual fee payable amount outputted thereon, wherein the display device displays an application and/or patent list constituting the one or more groups of the patent applications and/or the patents selected by the patent portfolio selection unit, and the control device performs control to have selected one or more patent applications and/or patents to be maintained, to have the annual fee payable amount calculation unit calculate the patent annual fee payable amount, and to have the patent annual fee payable amount outputted on the patent portfolio management screen.

7. The patent portfolio management apparatus as set forth in claim 1, wherein the application evaluation information further includes an invention practice status, a licensing status and an importance factor.

8. The patent portfolio management apparatus as set forth in claim 1, wherein at least a part of the patent information storage unit, the annual fee information storage unit, the patent value calculation unit, the annual fee payable amount calculation unit, the graphics generation unit and the display device is connected with a remaining part other than the part thereof through a network.

9. The patent portfolio management apparatus as set forth in claim 2, wherein at least a part of the patent information storage unit, the annual fee information storage unit, the patent value calculation unit, the annual fee payable amount calculation unit, the graphics generation unit, the display device and the input device is connected with a remaining part other than the part thereof through a network.

10. The patent portfolio management apparatus as set forth in claim 3, further comprising:
a reference value score setting unit which sets a reference value score; and
a patent portfolio group extraction unit which extracts the patent portfolio group having the value score lower than the reference value score.

11. A patent portfolio management method, comprising:
a step of storing a patent application number, a patent portfolio management number and patent data used for patent evaluation into a patent information storage unit, which stores therein patent-related information of patent applications and/or patents for an evaluation;
a step of calculating a value score of each of patent applications and patents stored in the patent information storage unit;
a calculation step of calculating a patent annual fee payable amount of a reference year per each of the patent applications and/or patents stored in the patent information storage unit, based upon an annual fee table containing information of annual maintenance fees for at least one country;
a calculation step of segmenting the patent applications and/or patents stored in the patent information storing unit into segments each of which is associated with the patent portfolio management number, and having an annual fee calculation unit calculate the value score and the patent annual fee payable amount per a group of patent applications and/or patents having a predetermined relationship with each other to constitute a patent portfolio;
a patent portfolio management screen generation step of generating a predetermined diagram or a predetermined table in accordance with the value score and the patent annual fee payable amount, the value score being a score of the group of patent applications and/or patents having a predetermined relationship with each other to constitute the patent portfolio or a score of each of patent applications and/or patents forming a part of the group of patent applications and patents, the patent annual fee payable amount being an amount calculated in the first calculation step or the second calculation step; and
a step of displaying the patent portfolio management screen generated in the patent portfolio management screen generation step.

12. The patent portfolio management method as set forth in claim 11, further comprising:
a step of accepting a retrieval data for extracting the patent applications and/or patents subject for an evaluation; and
a step of retrieving the patent applications and/or patents subject for the evaluation from a first storage unit having therein a bibliographic data related to patent, based upon the retrieval data inputted in the step of accepting the retrieval data, wherein the step of storing the patent application number, the patent portfolio management number and the patent data used for patent evaluation into the patent information storage unit includes storing in the patent information storage unit the patent application number, the patent portfolio management number and the patent data used for the patent evaluation retrieved in the step of retrieving the patent applications and/ patents subject for the evaluation from the first storage unit having therein the bibliographic data related to patent, based upon the retrieval data inputted in the step of accepting the retrieval data.

13. The patent portfolio management method as set forth in claim 12, further comprising:
a second acceptance step of accepting a patent maintenance request or a patent non-maintenance request per the patent portfolio or per each of the patent applications and/or patents on the patent portfolio management screen displayed in the displaying step;
a step of having the patent annual fee payable amount for the reference year calculated in the first calculation step or the second calculation step; and
a step of having the annual fee calculation unit calculate the patent annual fee payable amount for the reference year based upon the patent maintenance request or the patent non-maintenance request accepted in the second acceptance step,
a step of having the patent annual fee payable amount outputted on the patent portfolio management screen.

14. The patent portfolio management method as set forth in claim 13, wherein the second acceptance step, the third calculation step and the output step are iterated, and the second acceptance step being a step of accepting the patent maintenance request or the patent non-maintenance request per each of the groups of patent applications and/or patents mutually related with each other to constitute the patent portfolio or per each of the patent applications and patents on the patent portfolio management screen displayed in the displaying step.

15. The patent portfolio management method as set forth in claim 11, further comprising:
an extraction step of extracting the patent portfolio having a relatively low value score based upon the value score calculated for each of the patent portfolios; and
a control step of having the patent annual fee payable amount for the reference year of each of the patent applications and patents constituting the portfolio extracted in the extraction step calculated in the first calculation step and having the patent annual fee payment amount outputted on the patent portfolio management screen.

16. The patent portfolio management method as set forth in claim 11, further comprising:
a step of setting a reference value score; and
a step of extracting the patent portfolio group having the value score lower than the reference value score.
